(19) United States
(12) Patent Application Publication
(10) Pub. No.: US 2024/0376300 A1
(43) Pub. Date: Nov. 14, 2024

(54) RESIN COMPOSITION, MOLDED OBJECT, MULTILAYERED OBJECT, METHOD FOR PRODUCING POLY(ARYLENE ETHER), AND POLY(ARYLENE ETHER)

(71) Applicants: IDEMITSU KOSAN CO., LTD., Tokyo (JP); UNIVERSITY OF FUKUI, Fukui-shi, Fukui (JP)

(72) Inventors: Kenta ITO, Tokyo (JP); Ken SUDO, Tokyo (JP); Yohei KOORI, Tokyo (JP); Hiroshi YASUDA, Tokyo (JP); Hideyuki UEMATSU, Fukui-shi (JP); Masachika YAMANE, Fukui-shi, shi (JP); Shuichi TANOUE, Fukui-shi (JP); Ayaka YAMAGUCHI, Fukui-shi (JP)

(73) Assignees: IDEMITSU KOSAN CO., LTD., Tokyo (JP); UNIVERSITY OF FUKUI, Fukui-shi , Fukui (JP)

(21) Appl. No.: 18/564,574

(22) PCT Filed: May 27, 2022
(86) PCT No.: PCT/JP2022/021674

§ 371 Date: Nov. 27, 2023

(30) Foreign Application Priority Data
May 28, 2021 (JP) 2021-090142

(51) Int. Cl. C08L 25/06; C08K 7/06

(52) U.S. Cl. CPC C08L 25/06; C08K 7/06; C08L 2207/10

(57) ABSTRACT

A resin composition comprising a resin(S) comprising: a polyerytene other (A) having a ratio of peak integral value of 3.80 to 3.92 ppm relative to a peak integral value of 6.20 to 6.72 ppm being 0.05 to 5.0%, in ¹H-NMR spectrum obtained by ¹H-NMR spectrum measurement using deuterated chloroform as a solvent, and a thermoplastic resin (B), and an inorganic filler (C).

### CROSS-REFERENCE TO RELATED APPLICATIONS

The present application claims priority under 35 U.S.C. § 371 to International Patent Application No. PCT/JP2022/021674, filed May 27, 2022, which claims priority to and the benefit of Japanese Patent Application No. 2021-090142, filed May 28, 2021. The contents of these applications are hereby incorporated by reference in their entireties.

### TECHNICAL FIELD

The invention relates to a resin composition capable of exhibiting excellent mechanical strength, a formed body, a stacked body, a method for producing a polyarylene ether, and a polyarylene ether.

### BACKGROUND ART

Reduction of CO₂ emissions from automobiles is required to prevent global warming. Therefore, fuel efficiency standards tend to be stricter around the world, and the weight reduction of the vehicle body is strongly desired. Carbon fiber-reinforced resins (hereinafter sometimes abbreviated as “CFRP”) made of a resin and a carbon fiber (hereinafter sometimes abbreviated as “CF”) have been widely studied as a lightweight material. Among resins, carbon fiber-reinforced thermoplastic resins (hereinafter, sometimes abbreviated as “CFRTP”) including a thermoplastic resin having excellent productivity are expected to grow in the future.

However, it is difficult to increase the adhesive strength between a resin and CF, i.e., the interfacial shear strength, because CF has fewer functional groups on the fiber surface. In order to increase the adhesiveness by improving the affinity of the resin/CF interface, Patent Document 1 discloses a resin composition containing a polyarylene ether modified with a functional group and a thermoplastic resin, and a carbon fiber.

### RELATED ART DOCUMENTS

### Patent Documents

[Patent Document 1] WO2020/174748

### SUMMARY OF THE INVENTION

However, the adhesiveness at the resin/CF interface is not sufficient in the above-described art. Therefore, in the development of the mechanical strength of CFRTP, destroy occurs from the resin/CF interface, and the strength which the resin and CF inherently have (e.g., mechanical strength such as flexural strength) cannot be sufficiently exhibited. This problem occurs not only in the case where CF is employed as a reinforcing material, but also in a resin/an inorganic filler interface in the case where various inorganic fillers are employed.

An object of the invention is to provide a resin composition capable of exhibiting excellent mechanical strength, a formed body, a stacked body, a method for producing a polyarylene ether, and a polyarylene ether.

In view of the above problems, the inventors have studied to obtain a resin composition capable of exhibiting excellent mechanical strength. As a result, the inventors found that a resin composition containing resin(S) containing a polyarylene ether (A) having a ratio of a peak integral value of 3.80 to 3.92 ppm relative to a peak integral value of 6.20 to 6.72 ppm being 0.05 to 5.0%, in ¹H-NMR spectrum obtained by ¹H-NMR spectrum measurement using deuterated chloroform as a solvent; and a thermoplastic resin (B), and an inorganic filler (C), is capable of exhibiting excellent mechanical strength, and thus can solve the above problem.

According to the invention, the following resin composition and so on can be provided.

1. A resin composition comprising:
a resin(S) comprising:
   a polyarylene ether (A) having a ratio of a peak integral value of 3.80 to 3.92 ppm relative to a peak integral value of 6.20 to 6.72 ppm being 0.05 to 5.0%, in ¹H-NMR spectrum obtained by ¹H-NMR spectrum measurement using deuterated chloroform as a solvent; and
   a thermoplastic resin (B), and
an inorganic filler (C).

2. A resin composition comprising:
a resin(S) comprising:
   a polyarylene ether (A); and
   a thermoplastic resin (B), and
an inorganic filler (C), wherein
a ratio of a peak integral value of 3.80 to 3.92 ppm relative to a peak integral value of 6.20 to 6.72 ppm is 0.05 to 5.0%, in ¹H-NMR spectrum for the resin composition obtained by ¹H-NMR spectrum measurement using deuterated chloroform as a solvent . . .

3. A resin composition comprising:
a resin(S) comprising:
   a polyarylene ether (A); and
   a thermoplastic resin (B), and
an inorganic filler (C), wherein
a ratio of a value obtained by dividing a peak integral value of 3.80 to 3.92 ppm by 2, relative to a sum of a value obtained by dividing a peak integral value of 1.96 to 2.43 ppm by 6 and a value obtained by dividing a peak integral value of 3.80 to 3.92 ppm by 2 is 0.05 to 5.0%, in ¹H-NMR spectrum for the resin composition obtained by ¹H-NMR spectrum measurement using deuterated chloroform as a solvent.

4. The resin composition according to any one of 1 to 3, wherein the polyarylene ether (A) is a polyarylene ether modified with a functional group.

5. The resin composition according to any one of 1 to 4, wherein the polyarylene ether (A) is a dicarboxylic acid-modified polyarylene ether.

6. The resin composition according to any one of 1 to 4, wherein the polyarylene ether (A) is a fumaric acid-modified polyarylene ether or a maleic anhydride-modified polyarylene ether.

7. The resin composition according to any one of 1 to 6, wherein the polyarylene ether (A) is contained in an amount of 0.5 to 30% by mass in 100% by mass of the resin(S).

8. The resin composition according to any one of 1 to 7, comprising the inorganic filler (C) in an amount of 1 to 500 parts by mass relative to 100 parts by mass of the resin(S).

9. The resin composition according to any one of 1 to 8, wherein the thermoplastic resin (B) is at least one selected from the group consisting of a polycarbonate-based resin, a polystyrene-based resin, a polyamide, and a polyolefin.

10. The resin composition according to any one of 1 to 9, wherein the thermoplastic resin (B) is a styrene-based resin having a syndiotactic structure.

11. The resin composition according to any one of 1 to 10, wherein the inorganic filler (C) is an inorganic fiber.

12. The resin composition according to 11, wherein the inorganic fiber is carbon fiber.

13. The resin composition according to 12, wherein the carbon fiber is at least one carbon fiber selected from the group consisting of a PAN-based carbon fiber, a pitch-based carbon fiber, a heat-curing carbon fiber, a phenol-based carbon fiber, a vapor-phase growth carbon fiber, and a recycled carbon fiber (RCF).

14. A formed body, comprising the resin composition according to any one of 1 to 13.

15. The formed body according to 14, which is a unidirectional fiber reinforcing material.

16. The formed body according to 14, comprising at least one member selected from the group consisting of a woven carbon fiber and a non-woven carbon fiber.

17. The formed body according to 14, which is an injection-molded body.

18. A stacked body obtained by stacking a plurality of the formed bodies according to any one of 14 to 17.

19. A method for producing a polyarylene ether, comprising heat-treating a polyarylene ether at a temperature of 250 to 400° C. for 1 minute or longer to obtain a polyarylene ether (A) having a ratio of a peak integral value of 3.80 to 3.92 ppm, relative to a peak integral value of 6.20 to 6.72 ppm being 0.05 to 5.0%, in 1H-NMR spectrum obtained by ¹H-NMR spectrum measurement using deuterated chloroform as a solvent.

20. The method for producing a polyarylene ether according to 19, wherein a shear stress is applied to the polyarylene ether during the heat-treating.

21. The method for producing a polyarylene ether according to 19 or 20, producing the polyarylene ether (A) used in a carbon fiber-reinforced resin composition.

22. A polyarylene ether, having a ratio of a peak integral value of 3.80 to 3.92 ppm relative to a peak integral value of 6.20 to 6.72 ppm of 0.05 to 5.0%, in ¹H-NMR spectrum obtained by ¹H-NMR spectrum measurement using deuterated chloroform as a solvent.

23. The polyarylene ether according to 22, used for a carbon fiber-reinforced resin composition.

According to the invention, a resin composition capable of exhibiting excellent mechanical strength, a formed body, a stacked body, a method for producing a polyarylene ether, and a polyarylene ether can be provided.

### BRIEF DESCRIPTION OF THE DRAWINGS

FIG. 1 is the ¹H-NMR spectrum obtained in Example 1.

FIG. 2 is the ¹H-NMR spectrum obtained in Example 2.

FIG. 3 is the ¹H-NMR spectrum obtained in Example 3.

FIG. 4 is the ¹H-NMR spectrum obtained in Example 4.

FIG. 5 is the ¹H-NMR spectrum obtained in Comparative Example 1.

### MODE FOR CARRYING OUT THE INVENTION

Hereinafter, a resin composition, a formed body, a stacked body, a method for producing a polyarylene ether, and a polyarylene ether of the invention will be described in detail.

In this specification, “x to y” represents a numerical range of “x or more and y or less.” The upper limit and the lower limit stated for the numerical value ranges can be combined arbitrarily. In this specification, the features stated as preferred are not essential and can be arbitrarily adopted, and combinations of preferred features are more preferable.

### 1. Resin Composition

The resin composition according to an aspect of the invention contains resin(S) containing a polyarylene ether having a ratio of a peak integral value of 3.80 to 3.92 ppm relative to a peak integral value of 6.20 to 6.72 ppm is 0.05 to 5.0%, in ¹H-NMR spectrum obtained by ¹H-NMR spectrum measurement using deuterated chloroform as a solvent (hereinafter sometimes abbreviated as “the polyarylene ether (A)”); and a thermoplastic resin (B), and an inorganic filler (C).

The resin composition of this aspect is capable of exhibiting excellent mechanical strength (e.g., flexural strength).

In this specification, the term “resin composition” refers to a product containing at least the resin(S) and the inorganic filler (C), regardless of the manner of containing them. For example, a product obtained by blending the resin(S) and the inorganic filler (C), and a product obtained by impregnating the resin(S) into a member containing the inorganic filler (C) can be mentioned. In the case where the inorganic filler (C) is a member having the form of a woven fabric, a nonwoven fabric, or a unidirectional material, a composite material obtained by impregnating the member with the resin(S) is also included in the “resin composition” of the invention. In this specification, the case where an inorganic filler is “impregnated” with a resin or the like, includes any addition manner in which a resin component or the like is added to an inorganic filler.

### (Resin(S))

The resin(S) contained in the resin composition of this aspect contains a polyarylene ether (A) and a thermoplastic resin (B).

### (Polyarylene Ether (A))

The polyarylene ether (A) has a ratio of a peak integral (S2) value of 3.80 to 3.92 ppm relative to a peak integral value (S1) of 6.20 to 6.72 ppm, in ¹H-NMR spectrum obtained by ¹H-NMR spectrum measurement using deuterated chloroform as a solvent ((S2/S1×100 [%]), is 0.05 to 5.0%. The lower limit is 0.05% or more, preferably 0.1% or more, more preferably 0.2% or more, and still more preferably 0.3% or more. The upper limit is 5.0% or less, preferably 2.0% or less, and more preferably 1.0% or less.

In this specification, this ratio is also referred to as an “integral value ratio.”

The higher the integral value ratio is, the more the mechanical strength exhibited by the resin composition increases. However, the ratio of the integral value exceeding 5.0% adversely affects exhibition of the mechanical strength.

The integral value ratio is determined by the method described in Examples.

In ¹H-NMR spectrum for the polyarylene ether (A) obtained by ¹H-NMR spectrum measurement using deuterated chloroform as a solvent, the peak within a range of 6.20 to 6.72 ppm corresponds to a phenylene ether structure. Also, the peak within a range of 3.80 to 3.92 ppm corresponds to a methylene bridge structure.

Consequently, a ratio of the value (12) obtained by dividing the peak integral value of 3.80 to 3.92 ppm by the number of protons derived from methylene bridge structure of 2, relative to the value (11) obtained by dividing the peak integral value of 6.20 to 6.72 ppm by the number of protons derived from phenylene ether structure of 2, ((I₂/I₁)×100 [%]), may be an index indicating the ratio of the methylene bridge structure (hereinafter, also referred to as “MB structure”) in the polyarylene ether (A). In this specification, this ratio is also referred to as “MB rearrangement ratio”. In this specification, the term “MB structure” refers to a structure in which two arylene groups are linked (bridged) by a methylene group.

In one embodiment, the polyarylene ether (A) has the MB rearrangement ratio of 0.05% or more, 0.1% or more, 0.2% or more, or 0.3% or more. The upper limit is not particularly limited, and is, for example, 5.0% or less, preferably 2.0% or less, and more preferably 1.0% or less.

The higher MB rearrangement ratio is, the more the mechanical strength exhibited by the resin composition increases. However, the MB rearrangement ratio exceeding 5.0% adversely affects exhibition of the mechanical strength.

The explanation as to the MB rearrangement ratio described above is also applied to the second aspect and the third aspect described later.

The MB structure that may be contained in the polyarylene ether (A), will be described below with reference to poly(2,6-dimethyl-1,4-phenylether) as an example.

A polyarylene ether having no MB structure (hereinafter, also referred to as “polyarylene ether (A′)”) is composed of a repeating unit (monomer unit) having an arylene ether structure as represented by the following formula (1).

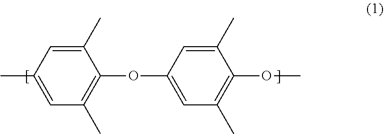

In contrast, in one embodiment, the polyarylene ether (A) contains a MB structure in which two arylene groups are linked (bridged) by a methylene group. Such a MB structure can be formed by rearrangement (MB rearrangement) of at least some of the arylene ether structures having no MB structure as represented by the formula (1) of the polyarylene ether (A).

In one embodiment, the polyarylene ether (A) has a MB structure represented by the formula (2) below.

In one embodiment, the MB structure has a hydroxy group bonded to at least one of the two arylene groups bonded to the methylene group, as represented by the formula (2) below. This hydroxy group may be a phenolic hydroxy group.

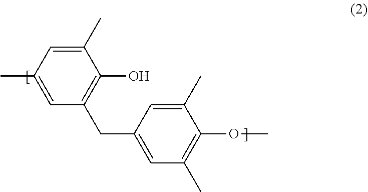

In one embodiment, the polyarylene ether (A) has a MB structure represented by the formula (3) below.

In one embodiment, the MB structure has no hydroxy group bonded to either of the two arylene groups bonded to the methylene group, as represented by the formula (3) below.

In one embodiment, a MB structure results in branching of the polymer backbone starting from the MB structure, as represented by the formula (3) below.

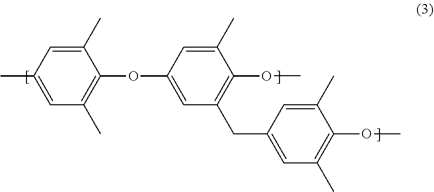

In one embodiment, the polyarylene ether (A) has one or more selected from the group consisting of the MB structure represented by the formula (2) and the MB structure represented by the formula (3). In one embodiment, the polyarylene ether (A) has, relative to the total number of MB structures, one or more selected from the group consisting of the MB structure in which a hydroxy group is bonded to at least one of the two arylene groups bonded to the methylene group and the MB structure resulting in branching of the polymer backbone.

The type of the polyarylene ether (A) is not particularly limited, and examples thereof include the following polyarylene ethers. The polyarylene ether (A) may be polyarylene ethers in which the MB structure is introduced to the following polyarylene ethers.

Examples of the polyarylene ether include poly(2,3-dimethyl-6-ethyl-1,4-phenylene ether), poly(2-methyl-6-chloromethyl-1,4-phenylene ether), poly(2-methyl-6-hydroxylethyl-1,4-phenylene ether), poly(2-methyl-6-n-butyl-1,4-phenylene ether), poly(2-ethyl-6-isopropyl-1,4-phenylene ether), poly(2-ethyl-6-n-propyl-1,4-phenylene ether), poly(2,3,6-trimethyl-1,4-phenylene ether), poly [2-(4′-methylphenyl)-1,4-phenylene ether], poly(2-phenyl-1,4 phenylene ether), poly(2-chloro-1,4-phenylene ether), poly(2-methyl-1,4-phenylene ether), poly(2-chloro-6-ethyl-1,4-phenylene ether), poly(2-chloro-6-bromo-1,4-phenylene ether), poly(2,6-di-n-propyl-1,4-phenylene ether), poly(2-methyl-6-isopropyl-1,4-phenylene ether), poly(2-chloro-6-methyl-1,4-phenylene ether), poly(2-methyl-6-ethyl-1,4-phenylene ether), poly(2,6-dibromo-1,4-phenylene ether), poly(2,6-dichloro-1,4-phenylene ether), poly(2,6-diethyl-1,4-phenylene ether), poly(2,6-dimethyl-1,4-phenylene ether), and the like. Alternatively, the polymers and copolymers described in U.S. Pat. Nos. 3,306,874, 3,306,875, 3,257,357, and 3,257,358 are also suitable. Also, graft copolymers and block copolymers composed of a vinyl aromatic compound such as polystyrene and the above-mentioned polyphenylene ether can be given. Among these, poly(2,6-dimethyl-1,4-phenylene ether) is particularly preferably used.

The polyarylene ether (A) may be modified with a functional group or may not be modified with a functional group. The functional group referred to herein does not include a methylene group linking (bridging) two arylene groups in the above-described MB structure.

The polyarylene ether (A) is preferably modified with a functional group, whereby further increases mechanical strength.

The polyarylene ether modified with a functional group can be obtained by reacting the polyarylene ether exemplified above with the modifying agent described below.

Upon being subjected to reaction with the modifying agent, the polyarylene ether may have the MB structure or may not have the MB structure. Further, the MB rearrangement may proceed after the reaction with the modifying agent, or the MB rearrangement may proceed simultaneously with the reaction with the modifying agent.

Examples of the modifying agent for modifying the polyarylene ether include an acid modifying agent. Examples of the acid modifying agent include dicarboxylic acid and its derivatives.

Examples of the dicarboxylic acid used as the modifying agent include maleic anhydride and its derivatives, and fumaric acid and its derivatives. The derivative of maleic anhydride is a compound having an ethylenic double bond and a polar group such as a carboxyl group or an acid anhydride group in the same molecule. Specifically, examples thereof include maleic acid, maleate monoester, maleate diester, an ammonium salt of maleate, a metal salt of maleate, acrylic acid, methacrylic acid, methacrylate ester, glycidyl methacrylate, and the like. Specific examples of the fumaric acid derivative include fumaric acid diester, fumaric acid metal salt, ammonium fumarate salt, fumaric acid halide, and the like. Among these, fumaric acid or maleic anhydride is particularly preferably used.

The polyarylene ether modified with a functional group is preferably a dicarboxylic acid-modified polyarylene ether, and more preferably a fumaric acid-modified polyarylene ether or a maleic acid-modified polyarylene ether. Specific examples thereof include modified polyphenylene ether-based polymers such as (styrene-maleic anhydride)-polyphenylene ether-graft polymer, maleic anhydride-modified polyphenylene ether, fumaric acid-modified polyphenylene ether, glycidyl methacrylate-modified polyphenylene ether, and amine-modified polyphenylene ether. Among them, a modified polyphenylene ether is preferred, maleic anhydride-modified polyphenylene ether or fumaric acid-modified polyphenylene ether is more preferred, and fumaric acid-modified polyphenylene ether is particularly preferred.

The modification degree (ratio of modification, degree of modification, or amount of modification) of a polyarylene ether modified with a functional group can be determined by ¹H-NMR measurement, infrared (IR) absorption spectroscopy, or titration method.

When the degree of modification is determined by ¹H-NMR measurement, for example, when the modifying agent is fumaric acid, the degree of modification is determined from a ratio of the value (13) obtained by dividing a peak integral value of 3.06 to 3.17 ppm (corresponding to the position of methylene bonded with fumaric acid) by the number of the proton derived from the structure of the position of methylene bonded with fumaric acid of 1, relative to the value (11) obtained by dividing a peak integral value of 6.20 to 6.72 ppm (corresponding to the phenylene ether structure) by the number of protons derived from the phenylene ether structure of 2, in ¹H-NMR spectrum obtained by ¹H-NMR spectrum measurement using deuterated chloroform as a solvent ((13/l1)×100 [%], also referred to as a “ratio of modification with fumaric acid”). The ratio of modification with fumaric acid is preferably 0.01 to 20%.

When the degree of modification is obtained by infrared (IR) absorption spectroscopy, the degree of modification can be obtained from the intensity ratio of the spectrum of the peak intensity indicating the absorption of a compound used as the modifying agent and the peak intensity indicating the absorption of the corresponding polyarylene ether. For example, in the case of fumaric acid-modified polyphenylene ether, the degree of modification is determined by the equation: degree of modification=(A)/(B), wherein the ratio of the peak intensity (A) of 1790 cm⁻¹ indicates the absorption of fumaric acid and the peak intensity (B) of 1704 cm⁻¹ indicates the absorption of polyphenylene ether (PPE). The degree of modification of the polyarylene ether (A) modified with functional group is preferably 0.05 to 20.

When the amount of modification is determined by titration method, the amount of modification can be determined as the acid content from the neutralized titration amount measured according to JIS K 0070:1992. The amount of modification of the polyarylene ether (A) modified with a functional group is preferably from 0.1 to 20% by mass, more preferably from 0.5 to 15% by mass, still more preferably from 1.0 to 10% by mass, and particularly preferably from 1.0 to 5.0% by mass, based on the mass of the polyarylene ether.

The degree of polymerization of the polyarylene ether (A) is not particularly limited, and can be appropriately selected depending upon the purpose of use or the like, and can be selected from, for example, a range of 60 to 400.

In one embodiment, the number-average molecular weight Mn of the polyarylene ether (A) is preferably from 9,000 to 50,000, more preferably from 9,500 to 30,000, and still more preferably from 10,000 to 20,000. When the number-average molecular weight Mn is 9,000 or more, the toughness of the polyarylene ether (A) is increased and excellent mechanical properties can be obtained. In addition, when the number-average molecular weight Mn is 50,000 or less, the melt viscosity is suppressed from being excessively high, and excellent formability can be obtained.

In one embodiment, the molecular weight distribution Mw/Mn of the polyarylene ether (A) is from 0.5 to 10.0.

The degree of polymerization, the number-average molecular weight Mn, and the molecular weight distribution Mw/Mn of the polyarylene ether (A) are determined by gel permeation chromatography (GPC) using chloroform as a solvent and comparing with the elution times of the polystyrene standards of known molecular weights.

### (Thermoplastic Resin (B))

The thermoplastic resin (B) contained in the resin composition of this aspect is not particularly limited, but the polyarylene ether (A) described above does not fall within the thermoplastic resin (B).

Specific examples of the thermoplastic resin (B) include polyamide resin, acrylic resin, polyphenylene sulfide resin, polyvinyl chloride resin, polystyrene-based resin, polyolefin, polyacetal resin, polycarbonate-based resin, polyurethane, polybutylene terephthalate, acrylonitrile butadiene styrene (ABS) resin, modified polyphenylene ether resin, phenoxy resin, polysulfone, polyether sulfone, polyether ketone, polyether ether ketone, aromatic polyester, and the like. Among them, at least one kind selected from the group consisting of polycarbonate-based resin, polystyrene-based resin, polyamide, and polyolefin is preferable, and polyamide, polycarbonate-based resin, or polystyrene-based resin is more preferable. According to one embodiment, the thermoplastic resin (B) is polystyrene-based resin or polyamide.

The polystyrene-based resin is not particularly limited, and examples thereof include homopolymers of a styrene-based compound, copolymers of two or more styrene-based compounds, rubber-modified polystyrene resins (high-impact polystyrenes) obtained by dispersing a rubber-like polymer in the form of a particulate in a matrix composed of a polymer of a styrene-based compound, and the like. Examples of the styrene-based compound as a raw material include styrene, o-methylstyrene, p-methylstyrene, m-methylstyrene, α-methylstyrene, ethylstyrene, α-methyl-p-methylstyrene, 2,4-dimethylstyrene, monochlorostyrene, p-tert-butylstyrene, and the like.

The polystyrene-based resin may be a copolymer obtained by using two or more kinds of styrene-based compounds in combination. However, among the polystyrene-base resins, polystyrene obtained by polymerization using styrene alone is preferable. Examples thereof include polystyrene having a stereoregular structure such as atactic polystyrene, isotactic polystyrene, and syndiotactic polystyrene. The thermoplastic resin (B) contained in the resin composition of the invention is preferably styrene-based resin having a syndiotactic structure (syndiotactic polystyrene).

The syndiotactic polystyrene means styrene-based resin having a high syndiotactic structure (hereinafter, sometimes abbreviated as “SPS”). In this specification, “syndiotactic” means that the proportion of the phenyl rings in adjacent styrene units arranged alternately based on the plane formed by the main chain of the polymer block (hereinafter, referred to as “syndiotacticity”) is high.

The syndiotacticity can be quantitatively identified by isotope-carbon nuclear magnetic resonance (13C-NMR). By 13C-NMR, it is possible to quantify the abundance proportion of constituent units composed of a plurality of consecutive monomers, for example, as two consecutive monomer units as diads, three monomer units as triads, and five monomer units as pentads.

The term “styrene-based resin having a high syndiotactic structure” means polystyrene, poly(hydrocarbon-substituted styrene), poly(halogenated styrene), poly(halogenated alkylstyrene), poly(alkoxystyrene), poly(vinyl benzoate ester), hydrogenated polymers or mixtures thereof, or copolymers composed mainly thereof, which has a syndiotacticity of normally 75 mol % or more, and preferably 85 mol % or more in a racemic diad (r) fraction, or normally 30 mol % or more, and preferably 50 mol % or more in a racemic pentad (mr) fraction.

Examples of the poly(hydrocarbon-substituted styrene) include poly(methylstyrene), poly(ethylstyrene), poly(isopropylstyrene), poly(tert-butylstyrene), poly(phenyl) styrene, poly(vinylnaphthalene), poly(vinylstyrene), and the like. Examples of the poly(halogenated styrene) include poly(chlorostyrene), poly(bromostyrene), poly(fluorostyrene), and the like, and examples of the poly(halogenated alkylstyrene) include poly(chloromethylstyrene) and the like. Examples of the poly(alkoxystyrene) include poly(methoxystyrene), poly(ethoxystyrene), and the like.

Among the above styrene-based polymers, particularly preferred are polystyrene, poly(p-methylstyrene), poly(m-methylstyrene), poly(p-tert-butylstyrene), poly(p-chlorostyrene), poly(m-chlorostyrene), and poly(p-fluorostyrene).

Further, a copolymer of styrene and p-methylstyrene, a copolymer of styrene and p-tert-butylstyrene, a copolymer of styrene and divinylbenzene, and the like can be given.

Although the molecular weight of the syndiotactic polystyrene is not particularly limited, the weight-average molecular weight is preferably 1×10⁴ or more and 1×10⁶ or less, more preferably 50,000 or more and 500,000 or less, and still more preferably 50,000 or more and 300,000 or less, from the viewpoint of the fluidity of the resin at the time of forming and the mechanical properties of a formed body to be obtained. When the weight-average molecular weight is 1×10⁴ or more, a formed body having sufficient mechanical properties can be obtained. On the other hand, when the weight-average molecular weight is 1×10⁶ or less, the fluidity of the resin at the time of forming is not problematic.

MFR (melt flow rate) of the syndiotactic polystyrene is preferably 2 g/10 min or higher, preferably 4 g/10 min or higher, and within this range, the fluidity of the resin at the time of forming is not problematic. When the MFR is 50 g/10 min or lower, preferably 40 g/10 min or lower, and more preferably 30 g/10 min or lower, a formed body having sufficient mechanical properties can be obtained.

MFR is a value measured at a temperature of 300° C. under a load of 1.2 kg in accordance with JIS K 7210-1:2014.

As the polyamide, all known polyamides can be used.

Examples of the suitable polyamide include, for example, polyamide-4, polyamide-6, polyamide-6,6, polyamide-3,4, polyamide-12, polyamide-11, polyamide-6,10, polyamide-4T, polyamide-6T, polyamide-9T, polyamide-10T, and polyamides obtained from adipic acid and m-xylylenediamine. Among them, polyamide-6,6 is preferable.

### (Inorganic Filler (C))

The inorganic filler (C) contained in the resin composition of the present aspect is not particularly limited. Since the number of functional groups on the surface of the inorganic filler (C) is small, it is usually difficult to obtain the interfacial shear strength at the resin/inorganic filler interface, but according to the invention, the interfacial shear strength can be increased and the mechanical strength which the resin composition capable of exhibiting can be increased.

Examples of the inorganic filler (C) include inorganic fibers and the like. Examples of the inorganic fiber include carbon fiber, glass fiber, and the like. Among them, carbon fiber is preferable.

As the carbon fiber, various carbon fibers such as a PAN-based fiber made of polyacrylonitrile, a pitch-based fiber made of coal tar pitch in petroleum or coal, and a thermosetting resin, for example, phenol-based fiber made of phenol resin can be used. The carbon fiber may be one obtained by a vapor deposition method or may be a recycled carbon fiber (RCF). Carbon fiber is not particularly limited as described above, and at least one carbon fiber selected from the group consisting of PAN-based carbon fiber, pitch-based carbon fiber, heat-curing carbon fiber, phenol-based carbon fiber, vapor-grown carbon fiber, and recycled carbon fiber (RCF) is preferable.

Although there are carbon fibers having various graphite degrees depending on the raw material quality and firing temperature at the time of production, the carbon fibers having any graphite degree can be used. The shape of the carbon fiber is not particularly limited, and carbon fiber having at least one shape selected from the group consisting of milled fiber, bundled cut (chopped strand), short fiber, roving, filament, tow, whisker, nanotube, and the like may be used. In the case of bundled cut (chopped strand), carbon fiber having the average fiber length of 0.1 to 50 mm and the average fiber diameter of 5 to 20 μm is preferably used.

The density of the carbon fiber is not particularly limited, and one having the density of 1.75 to 1.95 g/cm³ is preferred.

When the inorganic filler (C) is an inorganic fiber such as carbon fiber, glass fiber, or the like, the form of the inorganic fiber may be single fiber or fiber bundle, or both of the single fiber and the fiber bundle may be mixed. The number of the single fibers constituting each fiber bundle may be substantially uniform or may be different from each other. The average fiber diameter of the inorganic fiber varies depending on the form, and for example, the average fiber diameter is preferably 0.0004 to 15 μm, more preferably 3 to 15 μm, and still more preferably 5 to 10 μm.

As described above, in this specification, the “resin composition” may contain at least the resin(S) and the inorganic filler (C), and the manner of containing them in the resin composition is not limited. An article (composite material) obtained by immersing the resin(S) in a member containing the inorganic filler (C) is also included in the “resin composition” and the “formed body containing the resin composition” in the invention. For example, one that the resin(S) is impregnated into an inorganic fiber member in the form of a fabric, non-woven fabric, or a unidirectional material may be mentioned.

Further, after adding the polyarylene ether (A) to the inorganic filler (C) in advance, the thermoplastic resin (B) may be added thereto to obtain, as a consequence, a resin composition containing the resin(S) and the inorganic filler (C).

In the case where the member containing the inorganic fiber is a woven fabric, a nonwoven fabric, or a unidirectional material, single fibers having an average fiber diameter of preferably 3 to 15 μm, with more preferably 5 to 7 μm can be used. In addition, in a case where the member containing the inorganic fiber has a form of a woven fabric, a nonwoven fabric, or a unidirectional material, it is possible to use a bundle (fiber bundle) in which the inorganic fibers are bundled in one direction. As the member containing the inorganic fiber, a product of a bundle of 6000 (6K), 12000 (12K), 24000 (24K), or 60000 (60K) single fibers of the inorganic fiber supplied from inorganic fiber manufacturers may be used as the fiber bundle, or a bundle further bundled of the above bundles may be used. The fiber bundle may be any of a non-twisted yam, a twisted yam, and a untwisted yam. The fiber bundle may be contained in a state of being opened in a formed body, or may be contained as a fiber bundle without being opened. When the member containing the inorganic fiber is a woven fabric, a nonwoven fabric, or a unidirectional material, a formed body can be obtained by immersing the member in the resin(S).

The member containing the inorganic fiber, particularly a woven fabric, a nonwoven fabric, or a unidirectional material, preferably has a small thickness. From the viewpoint of obtaining a thin carbon-fiber composite material, the thickness of the member containing the inorganic fiber is preferably 3 mm or less. In particular, the unidirectional material preferably has a thickness of 0.2 mm or less. The lower limit of the thickness of the member containing the inorganic fiber is not particularly limited, and is preferably 7 μm or more, and is preferably 10 μm or more, and more preferably 20 μm or more from the viewpoint of stability in quality.

### (Sizing Agent)

When the inorganic filler (C) is inorganic fibers, the inorganic fibers may be ones' surface to which a sizing agent attaches. When the inorganic fiber to which the sizing agent is attached is used, the type of the sizing agent can be appropriately selected depending upon the type of the inorganic fiber and the thermoplastic resin, and is not particularly limited. Various commercial products of inorganic fibers such as those processed with an epoxy-based sizing agent, a urethane-based sizing agent, or a polyamide-based sizing agent, or those without sizing agent are on sale, and in the invention, the inorganic fiber can be used regardless of the type and presence of a sizing agent.

When an inorganic fiber to which a sizing agent is attached is used as the inorganic filler (C), the amount of the sizing agent may be 0.1 to 5.0% by mass based on the total amount of the inorganic filler (C) (including the inorganic fiber and the sizing agent).

From the viewpoint of increasing the interfacial shear strength between the resin(S) and the inorganic filler (C), the polyarylene ether (A) modified with the functional group is preferably contained in an amount of 0.5 to 30% by mass, more preferably 0.8 to 15% by mass, and still more preferably 1.0 to 10% by mass in 100% by mass of the resin(S). When the amount of the polyarylene ether (A) modified with a functional group in the resin(S) is 0.5% by mass or more, excellent interfacial shear strength can be obtained. When the amount of the polyarylene ether (A) is 30% by mass or less, mechanical strength and heat resistance can be maintained satisfactorily.

In one embodiment, the resin composition contains the inorganic filler (C) in an amount of preferably 1 to 500 parts by mass, more preferably 1 to 400 parts by mass, still more preferably 1 to 350 parts by mass, still more preferably 1 to 200 parts by mass, still more preferably 1 to 100 parts by mass, and still more preferably 1 to 50 parts by mass, based on 100 parts by mass of the resin(S). In order to obtain excellent strength, the resin composition preferably contains 15 parts by mass or more, and more preferably 20 parts by mass or more of the inorganic filler (C). When the amount of the inorganic filler (C) is within the above range, the more increased mechanical strength is exhibited.

### (Other Components)

One or more commonly used other components such as a rubber-like elastic material, an antioxidant, a filler other than the inorganic filler (C), a crosslinking agent, a crosslinking aid, a nucleating agent, a mold releasing agent, a plasticizer, a compatibilizer, a colorant, and/or an antistatic agent may be added to the resin composition of this aspect, as long as the object of the invention is not inhibited. Some of the other components are exemplified below.

As the rubber-like elastic material, various ones can be used. Examples thereof include, for example, natural rubber, polybutadiene, polyisoprene, polyisobutylene, chloroprene rubber, polysulfide rubber, Thiokol rubber, acrylic rubber, urethane rubber, silicone rubber, epichlorohydrin rubber, styrene-butadiene block copolymer (SBR), hydrogenated styrene-butadiene block copolymer (SEB), styrene-butadiene-styrene block copolymer (SBS), hydrogenated styrene-butadiene-styrene block copolymer (SEBS), styrene-isoprene block copolymer (SIR), hydrogenated styrene-isoprene block copolymer (SEP), styrene-isoprene-styrene block copolymer (SIS), hydrogenated styrene-isoprene-styrene block copolymer (SEPS), styrene-butadiene random copolymer, hydrogenated styrene-butadiene random copolymer, styrene-ethylene-propylene random copolymer, styrene-ethylene-butylene random copolymer, ethylene propylene rubber (EPR), ethylene propylenediene rubber (EPDM); core-shell type particulate elastic materials such as acrylonitrile-butadiene-styrene core-shell rubber (ABS), methylmethacrylate-butadiene-styrene core-shell rubber (MBS), methylmethacrylate-butylacrylate-styrene core-shell rubber (MAS), octylacrylate-butadiene-styrene core-shell rubber (MABS), alkylacrylate-butadiene-acrylonitrile-styrene core-shell rubber (AABS), butadiene-styrene core-shell rubber (SBR), siloxane-containing core-shell rubber such as methylmethacrylate-butylacrylate siloxane; and modified rubbers thereof, and the like.

Among these, SBR, SBS, SEB, SEBS, SIR, SEP, SIS, SEPS, core-shell rubbers, modified rubbers thereof, and the like are particularly, preferably used.

Examples of the modified rubber-like elastic material include modified rubbers such as styrene-butylacrylate copolymer rubber, styrene-butadiene block copolymer (SBR), hydrogenated styrene-butadiene-styrene block copolymer (SEB), styrene-butadiene-styrene block copolymer (SBS), hydrogenated styrene-butadiene-styrene block copolymer (SEBS), styrene-isoprene block copolymer (SIR), hydrogenated styrene-isoprene block copolymer (SEP), styrene-isoprene-styrene block copolymer (SIS), hydrogenated styrene-isoprene-styrene block copolymer (SEPS), styrene-butadiene random copolymer, hydrogenated styrene-butadiene random copolymer, styrene-ethylene-propylene random copolymer, styrene-ethylene-butylene random copolymer, ethylene propylene rubber (EPR), and ethylene propylenediene rubber (EPDM), which are modified with a modifying agent having a polar group.

As the filler other than the inorganic filler (C), an organic filler can also be added. Examples of the organic filler include organic synthetic fiber, natural plant fiber, and the like. Specific examples of the organic synthetic fiber include wholly aromatic polyamide fiber, polyimide fiber, and the like. The organic filler may be used alone or in combination of two or more kinds, and the addition amount thereof is preferably from 1 to 350 parts by mass, and more preferably from 5 to 200 parts by mass based on 100 parts by mass of the resin(S) or 100 parts by mass of the total amount of the unmodified polyarylene ether and the thermoplastic resin. When the amount is 1 part by mass or more, the effect of the filler is sufficiently obtained, and when the amount is 350 parts by mass or less, the dispersibility is not inferior and the formability is not adversely affected.

There are various kinds of antioxidants, and particularly preferred is a phosphorus-based antioxidant such as monophosphites and diphosphites such as tris(2,4-di-tert-butylphenyl) phosphite, tris(mono- and di-nonylphenyl) phosphite, and a phenol-based antioxidant.

As the diphosphite, a phosphorus-based compound represented by the following formula (4) is preferably used.

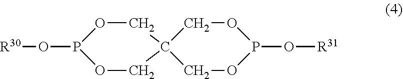

In the formula (4), R³⁰ and R³¹ independently represent an alkyl group including 1 to 20 carbon atoms, a cycloalkyl group including 3 to 20 carbon atoms, or an aryl group including 6 to 20 carbon atoms.

Specific examples of the phosphorus-based compound represented by the formula (4) include distearyl pentaerythritol diphosphite, dioctyl pentaerythritol diphosphite, diphenyl pentaerythritol diphosphite, bis(2,4-di-tert-butylphenyl) pentaerythritol diphosphite, bis(2,6-di-tert-butyl-4-methylphenyl) pentaerythritol diphosphite, dicyclohexylpentaerythritol diphosphite, and the like.

As a phenol-based antioxidant, known ones can be used, and specific examples thereof include 2,6-di-tert-butyl-4-methylphenol, 2,6-diphenyl-4-methoxyphenol, 2,2′-methylenebis(6-tert-butyl-4-methylphenol), 2,2′-methylenebis(6-tert-butyl-4-methylphenol), 2,2′-methylenebis [4-methyl-6-(α-methylcyclohexyl) phenol], 1,1-bis(5-tert-butyl-4-hydroxy-2-methylphenyl) butane, 2,2′-methylenebis(4-methyl-6-cyclohexylphenol), 2,2′-methylenebis(4-methyl-6-nonylphenol), 1,1,3-tris(5-tert-butyl-4-hydroxy-2-methylphenyl) butane, 2,2-bis(5-tert-butyl-4-hydroxy-2-methylphenyl)-4-n-dodecylmercaptobutane, ethylene glycol-bis [3,3-bis(3-tert-butyl-4 hydroxyphenyl) butyrate], 1,1-bis(3,5-dimethyl-2-hydroxyphenyl)-3-(n-dodecylthio)-butane, 4,4′-thiobis(6-tert-butyl-3-methylphenol), 1,3,5-tris(3,5-di-tert-butyl-4-hydroxybenzyl)-2,4,6-trimethylbenzene, 2,2-bis(3,5-di-tert-butyl-4 hydroxybenzyl) malonic acid dioctadecyl ester, n-octadecyl-3-(4-hydroxy-3,5-di-tert-butylphenyl) propionate, tetrakis [methylene (3,5-di-tert-butyl-4-hydroxyhydrocinnamate)]methane, and the like.

As antioxidants other than the phosphorus-based antioxidant and the phenol-based antioxidant above, an amine-based antioxidant, a sulfur-based antioxidant, and the like may be used alone or in combination.

The blending proportion of the antioxidant is usually 0.005 parts by mass or more and 5 parts by mass or less based on 100 parts by mass of the resin(S) or 100 parts by mass of the total amount of the polyarylene ether that has not yet undergone MB rearrangement and the thermoplastic resin. When the blending proportion of the antioxidant is 0.005 parts by mass or more, a decrease in the molecular weight of the thermoplastic resin (A) or the thermoplastic resin can be suppressed. When the blending proportion is 5 parts by mass or less, the mechanical strength can be maintained satisfactorily. When a plurality of the antioxidants are contained in the composition as the antioxidant, the total amount thereof is preferably adjusted so as to fall within the above range. The blending amount of the antioxidant is more preferably 0.01 to 4 parts by mass, and still more preferably 0.02 to 3 parts by mass, based on 100 parts by mass of the resin(S) or 100 parts by mass of the total amount of the polyarylene ether that has not yet undergone MB rearrangement and the thermoplastic resin.

As the nudleating agent, known ones, for example, metal salts of a carboxylic acid such as aluminum di(p-tert-butylbenzoate), metal salts of a phosphoric acid such as sodium methylenebis(2,4-di-tert-butylphenol) acid phosphate, talc, a phthalocyanine derivative, and the like can be arbitrarily selected and used. Specific trade names thereof include Adekastab NA-10, Adekastab NA-11, Adekastab NA-21, Adekastab NA-30, Adekastab NA-35, and Adekastab NA-70 manufactured by ADEKA CORPORATION, and PTBBA-AL manufactured by DIC Corporation, and the like. These nucleating agents may be used alone or in combination of two or more kinds. The blending amount of the nucleating agent is not particularly limited, and is preferably 0.01 to 5 parts by mass, and more preferably 0.04 to 2 parts by mass based on 100 parts by mass of the resin(S) or 100 parts by mass of the total amount of the polyarylene ether that has not yet undergone MB rearrangement and the thermoplastic resin.

The mold releasing agent may be selected from known ones such as polyethylene wax, silicone oil, long-chain carboxylic acid, and metals salt of long-chain carboxylic acid, and used. These mold releasing agents may be used alone or in combination of two or more kinds. The blending amount of the mold releasing agent is not particularly limited, and is preferably 0.1 to 3 parts by mass, and more preferably 0.2 to 1 parts by mass based on 100 parts by mass of the resin composition or 100 parts by mass of the total amount of materials forming a resin formed body.

In one embodiment, 50% by mass or more, 60% by mass or more, 70% by mass or more, 80% by mass or more, 90% by mass or more, 95% by mass or more, 97% by mass or more, 98% by mass or more, 99% by mass or more, 99.5% by mass or more, or substantially 100% by mass of the resin composition is composed of:
the polyarylene ether (A), the thermoplastic resin (B) and the inorganic filler (C), or
the polyarylene ether (A), the thermoplastic resin (B), the inorganic filler (C), and the other components described above.

In the case of “substantially 100% by mass”, inevitable impurities may be contained in the resin composition.

The method for producing (preparing) the resin composition of this aspect is not particularly limited, and may be mixed by a known mixer or may be melt-kneaded by an extruder or the like. A member containing the inorganic filler may be impregnated with the molten resin. For example, a composition of the resin(S), the inorganic filler (C), and various components described above, if necessary, can be formed and injection molded. In the injection molding, a mold having a predetermined shape may be used, and in the extrusion molding, a film or sheet may be T-die-molded, and the obtained film or sheet may be heated and melted to be extruded into a predetermined shape.

It is preferable to use a method of side-feeding inorganic fibers using a twin-screw kneader, or a method of producing a so-called long-fiber pellet that is cut into a desired pellet length after pultrusion molding by immersing an inorganic fiber (for example, carbon fiber) roving in a molten resin, because breakage of the inorganic fibers can be suppressed. The resin composition can also be press-formed, and known methods such as a cold press method and a hot press method can be used.

When a member containing the inorganic filler (C) is impregnated with the resin(S) to obtain a composite member, specifically, a solution of the resin(S) is impregnated into a member (woven fabric, non-woven fabric, UD material, or the like) containing the inorganic filler (C). The member to be impregnated with the resin may be a single member or a laminate formed by laminating two or more members.

In one embodiment, the flexural strength is 195 MPa or higher, 197 MPa or higher, 200 MPa or higher, or 202 MPa or higher. The upper limit is not particularly limited, and is, for example, 400 MPa or smaller. The flexural strength of the resin composition is measured by the method described in Examples.

The numerical value of the flexural strength can also be applied to the flexural strength of the following test piece.

In one embodiment, the resin composition containing the polyarylene ether (A) has the flexural strength measured on a test piece obtained by injection-molding pellets prepared by side-feeding and kneading 28 parts by mass of carbon fiber (“TR06UB4E,” chopped carbon fiber manufactured by Mitsubishi Chemical Corporation) using a biaxial kneader (“ZSK32MC” manufactured by Coperion Co., Ltd.) with a cylinder diameter of 32 mm to 100 parts by mass of a resin(S) composed of 5% by mass of the polyarylene ether (A) and 95% by mass of SPS (“Zarek 300 ZC” manufactured by Idemitsu Kosan Co., Ltd., MFR: 30 g/10 min), using an injection molding machine (“SH100” manufactured by Sumitomo Heavy Industries, Ltd.) under the conditions of a cylinder temperature of 300° C. and a mold temperature (ISO mold) of 150° C., and the flexural strength measured on the test piece is higher than 185 MPa, 186 MPa or higher, 187 MPa or higher, 190 MPa or higher, or 192 MPa or higher. The upper limit is not particularly limited, and is, for example, 350 MPa or lower.

Here, the flexural strength is measured by the method described in Examples.

The characteristics (performance of increasing the flexural strength) of the polyarylene ether (A) can also be applied to the polyarylene ether according to an aspect of the invention described later.

The resin composition according to an aspect of the invention (also referred to as “the first aspect”) described above is characterized in that a ratio of a peak integral value of 3.80 to 3.92 ppm relative to a peak integral value of 6.20 to 6.72 ppm, in ¹H-NMR spectrum of the polyarylene ether (A) obtained by ¹H-NMR spectrum measurement using deuterated chloroform as a solvent is 0.05 to 5.0%, but the invention is not limited to the first aspect.

The resin composition according to another aspect of the invention (also referred to as “the second aspect”) is a resin composition containing resin(S) containing a polyarylene ether (A) and thermoplastic resin (B), and an inorganic filler (C), wherein a ratio of the peak integral value of 3.80 to 3.92 ppm relative to the peak integral value of 6.20 to 6.72 ppm in a ¹H-NMR spectrum of the resin composition obtained by ¹H-NMR spectrum measurement using deuterated chloroform as a solvent is 0.05 to 5.0%.

The resin composition according to the second aspect also has good adhesion at the interface of resin/inorganic filler and is capable of exhibiting excellent mechanical strength (e.g., flexural strength).

In the second aspect, the polyarylene ether (A) may have a ratio of a peak integral value of 3.80 to 3.92 ppm relative to a peak integral value of 6.20 to 6.72 ppm in ¹H-NMR spectrum obtained by ¹H-NMR spectrum measurement using deuterated chloroform as a solvent of 0.05 to 5.0%, and the ratio may not be 0.05 to 5.0%. In the second aspect, the polyarylene ether (A) may be one satisfying the condition that the ratio of a peak integral value of 3.80 to 3.92 ppm relative to a peak integral value of 6.20 to 6.72 ppm in ¹H-NMR spectrum for the resin composition containing the polyarylene ether (A) obtained by ¹H-NMR spectrum measurement using deuterated chloroform as a solvent becomes 0.05 to 5.0%.

In the second aspect, as in the first aspect, in ¹H-NMR spectrum obtained by ¹H-NMR spectrum measurement using deuterated chloroform as a solvent, a peak within a range of 6.20 to 6.72 ppm corresponds to the phenylene ether structure of the polyarylene ether (A). Also, a peak within a range of 3.80 to 3.92 ppm corresponds to the methylene bridge structure of the polyarylene ether (A).

Accordingly, the ratio of the value (12) obtained by dividing a peak integral value of 3.80 to 3.92 ppm by the number of protons derived from methylene bridge structure of 2, relative to a value (11) obtained by dividing the peak integral value of 6.20 to 6.72 ppm by the number of protons derived from phenylene ether structure of 2, (I₂/I₁)×100 [%]) is a MB rearrangement ratio.

This MB rearrangement ratio can also be determined by ¹H-NMR spectrum measurement using a solvent other than deuterated chloroform, a mixed solvent, or the like as a solvent (this is not limited to the second aspect, but also possible in the first aspect). In such cases, each of the above-mentioned peaks may shift from the above-mentioned position observed when deuterated chloroform is used alone as a solvent.

For example, when a mixed solvent containing deuterated chloroform and deuterated benzene (benzene-d₆) in a mass ratio of 3:1 is used, a peak within a range of 1.96 to 2.43 ppm in ¹H-NMR spectrum corresponds to the methyl group bonded to the benzene ring in the phenylene ether structure, a peak within a range of 6.50 to 6.53 ppm corresponds to the phenylene ether structure, and a peak within a range of 3.73 to 3.82 ppm corresponds to the methylene bridge structure. The ratio of the value (IB) obtained by dividing the peak integral value of 3.73 to 3.82 ppm by the number of protons derived from methylene bridge structure of 2, relative to the value (IA) obtained by dividing the peak integral value of 6.50 to 6.53 ppm by the number of protons derived from phenylene ether structure of 2, (IB/IA)×100 [%]), is a ratio of the methylene bridge structure in the polyarylene ether (A) contained in the resin composition containing the polyarylene ether (A), that is, a MB rearrangement ratio. This MB rearrangement ratio may be 0.05 to 5.0%.

In the resin composition according to the second aspect, when in a ¹H-NMR spectrum, the peak derived from other components overlap with the peak derived from the polyarylene ether (A) and the integral values of the respective peaks described above are affected to each other, it is desirable to separate the peak derived from the other components and to obtain the integral value based on the peak derived from the polyarylene ether (A) in the ¹H-NMR spectrum.

¹H-NMR spectrum of the resin composition according to the second aspect can also be measured by various methods, for example, by subjecting a pulverized product of the resin composition to Soxhlet Warm and measuring ¹H-NMR spectrum of the obtained extract.

Other configurations of the resin composition according to the second aspect will be explained by referring to the explanation for the first aspect, and the detailed explanation will be omitted here.

The resin composition according to a further aspect of the invention (also referred to as “the third aspect”) contains a resin(S) containing a polyarylene ether (A) and a thermoplastic resin (B), and an inorganic filler (C), wherein in ¹H-NMR spectrum for the resin composition obtained by ¹H-NMR spectrum measurement using deuterated chloroform as a solvent, a ratio of a value obtained by dividing a peak integral value of 3.80 to 3.92 ppm by 2 relative to a sum of a value obtained by dividing a peak integral value of 1.96 to 2.43 ppm by 6 and a value obtained by dividing a peak integral value of 3.80 to 3.92 ppm by 2 is 0.05 to 5.0%.

The resin composition according to the third aspect also has good adhesion at the surface of resin/inorganic filler and is capable of exhibiting excellent mechanical strength (e.g., flexural strength).

In the third aspect, the polyarylene ether (A) may have a ratio of a peak integral value of 3.80 to 3.92 ppm relative to a peak integral value of 6.20 to 6.72 ppm in ¹H-NMR spectrum obtained by ¹H-NMR spectrum measurement using deuterated chloroform as a solvent of 0.05 to 5.0%, and the ratio may not be 0.05 to 5.0%. In the third aspect, the polyarylene ether (A) may be one satisfying the condition that the ratio obtained by dividing the peak integral value of 3.80 to 3.92 ppm by 2, relative to the sum of the value obtained by dividing the peak integral value of 1.96 to 2.43 ppm by 6 and the value obtained by dividing the peak integral value of 3.80 to 3.92 ppm by 2, in ¹H-NMR spectrum for the resin composition containing the polyarylene ether (A) obtained by 1H-NMR spectrum measurement using deuterated chloroform as a solvent, becomes 0.05 to 5.0%.

In the third aspect, in ¹H-NMR spectrum obtained by ¹H-NMR spectrum measurement using deuterated chloroform as a solvent, the peak within a range of 1.96 to 2.43 ppm corresponds to the two methyl groups bonded as substituents to the phenylene ether structure of the polyarylene ether (A). Also, the peak within a range of 3.80 to 3.92 ppm corresponds to the methylene bridge structure of the polyarylene ether (A).

Therefore, the ratio of the value (12) obtained by dividing a peak integral value of 3.80 to 3.92 ppm by the number of protons derived from the methylene bridge structure of 2, relative to the sum of the value (13) obtained by dividing a peak integral value of 1.96 to 2.43 ppm by the number of protons derived from the two methyl groups bonded as substituents to the phenylene ether structure of 6 and the value (12) obtained by dividing a peak integral value of 3.80 to 3.92 ppm by the number of protons derived from the methylene bridge structure of 2, (I₂/[I₃+I₂)×100 [%]), is MB rearrangement ratio.

This MB rearrangement ratio can also be determined by ¹H-NMR spectrum measurement using a solvent other than deuterated chloroform, a mixed solvent, or the like as a solvent. In such cases, each of the above-mentioned peaks may shift from the above-mentioned position observed when deuterated chloroform is used alone as a solvent.

As an example, when a mixed solvent containing deuterated chloroform and deuterated benzene (benzene-d₆) in a volume ratio of 3:1 is used as a solvent, the peak corresponding to the methylene bridge structure of the polyarylene ether (A) is shifted from the above-mentioned position (3.80 to 3.92 ppm) to 3.73 to 3.82 ppm. As a result, the ratio of the value obtained by dividing a peak integral value of 3.73 to 3.82 ppm by 2 relative to the sum of the value obtained by dividing a peak integral value of 1.96 to 2.43 ppm by 6 and the value obtained by dividing a peak integral value of 3.73 to 3.82 ppm by 2 corresponds to MB rearrangement ratio described above.

In the resin composition according to the third aspect, when in a ¹H-NMR spectrum, the peak derived from other components overlap with the peak derived from the polyarylene ether (A) and the integral values of the respective peaks described above are affected to each other, it is desirable to separate the peak derived from the other components and to obtain the integral value based on the peak derived from the polyarylene ether (A) in the ¹H-NMR spectrum.

¹H-NMR spectrum of the resin composition according to the second aspect can also be measured by various methods, for example, by subjecting a pulverized product of the resin composition to Soxhlet Warm and measuring ¹H-NMR spectrum of the obtained extract.

Other configurations of the resin composition according to the third aspect will be explained by referring to the explanation for the first aspect and the second aspect, and the detailed explanation will be omitted here.

### 2. Formed Body and Stacked Body

The formed body according to an aspect of the invention contains the resin composition according to the first aspect, the second aspect, or the third aspect of the invention described above.

The stacked body according to an aspect of the invention is obtained by stacking a plurality of formed bodies according to an aspect of the invention. The plurality of formed bodies to be stacked may be the same as or different from each other.

As described above, the formed body of this aspect can be formed by mixing, or melt-kneading the resin(S) and the organic filler (C), or immersing the inorganic filler (C) in the resin(S). As another method, a formed body can be formed by a method including a step of producing a member containing the polyarylene ether (A) and the inorganic filler (C), and a step of adding the thermoplastic resin (B) to the member.

The methods for producing the member containing the polyarylene ether (A) and the inorganic filler (C) is not particularly limited. Examples thereof include a method of immersing the inorganic filler (C) in the polyarylene ether (A) in the presence of a suitable solvent, a method of applying a mixture of the polyarylene ether (A) and a suitable vehicle to the inorganic filler (C), and a method of adding a mixture obtained by mixing the polyarylene ether (A) to the sizing agent, to the inorganic filler (C). When these methods are used, the inorganic filler (C) is preferably an inorganic fiber, and examples of the form of the inorganic fiber may include at least one form selected from a chopped strand, a woven fabric, a nonwoven fabric, or a unidirectional material.

The thermoplastic resin (B) is added to the member obtained by the above step in a subsequent step. The method of adding the thermoplastic resin (B) to the member is not limited, and the thermoplastic resin (B) may be in a solution state or a molten state. Specifically, a method in which the thermoplastic resin (B) is impregnated into the member in the presence of a suitable solvent, a method in which films containing the thermoplastic resin (B) are stacked and subjected to melt-press, a method in which a powder of the thermoplastic resin (B) is directly added to the member and then melted can be exemplified.

The member may contain the polyarylene ether (A) and the inorganic filler (C), and the thermoplastic resin (B) may be added to a member in a form of a woven fabric, a nonwoven fabric, or a unidirectional material, or a member in a form of a woven fabric or the like may be short-cut into a chopped form, and then the thermoplastic resin (B) may be added. After the thermoplastic resin (B) is added to the member, a formed body can be produced by various forming methods.

The shape of the formed body of this aspect is not particularly limited, and examples thereof include a sheet, a film, a fiber, a woven fabric, a nonwoven fabric, a unidirectional material (UD material), a container, an injection-molded body, a blow formed body, and so on. The formed body may be an injection-molded body as described above. Depending on the form of the inorganic filler used, the formed body may also be one containing a unidirectional fiber reinforcement or one containing at least one member selected from a woven carbon fiber and non-woven carbon fiber. A plurality of the formed bodies may be stacked to form a stacked body. This stacked body is also included in the “formed body” in this specification.

The formed body of this aspect can be used in various applications such as automobile applications.

Examples of the automotive applications include a sliding component such as a gear, an automotive panel member, a millimeter wave radome, an IGBT housing, a radiator grille, a meter hood, a fender support, a front engine cover, a front strut tower panel, a mission center tunnel, a radial core support, a front dash, a door inner, a rear luggage back panel, a rear luggage side panel, a rear luggage floor, a rear luggage partition, a roof, a door frame pillar, a seatback, a headrest support, an engine component, a crash box, a front floor tunnel, a front floor panel, an under cover, an under support rod, an impact beam, a front cowl, a front strut tower bar, and other automotive components.

The formed body of this aspect can suitably constitute a power electronic unit, a plug for rapid charging, an on-vehicle charger, a lithium ion battery, a battery control unit, a power electronic control unit, a three-phase synchronous motor, a plug for household charging, and the like, for example.

Further, the formed body of this aspect can suitably constitute a solar twilight sensor, an altemator, an EDU (electronic injector driver unit), an electronic throttle, a tumble control valve, a throttle opening sensor, a radiator fan controller, a stick coil, an A/C pipe joint, a diesel particulate collecting filter, a headlight reflector, a charge air duct, a charge air cooling head, an intake air temperature sensor, a gasoline fuel pressure sensor, a cam/crank position sensor, a combination valve, an engine oil pressure sensor, a transmission gear angle sensor, a continuously variable transmission oil pressure sensor, an ELCM (evaporative leak check module) pump, a water pump impeller, a steering roll connector, an ECU (engine computer unit) connector, an ABS (anti-lock braking system) reservoir piston, an actuator cover, and the like, for example.

The formed body of this aspect is also suitably used as a sealing material for sealing a sensor equipped in an in-vehicle sensor module, for example. The sensor is not particularly limited, and specific examples of the sensor include an atmospheric pressure sensor (e.g., for high ground correction), a boost pressure sensor (e.g., for fuel injection control), an (Integrated-Circuited) atmospheric pressure sensor, an acceleration sensor (e.g., for an airbag), a gauge pressure sensor (e.g., for sheet condition control), an in-tank pressure sensor (e.g., for fuel tank leak detection), a refrigerant pressure sensor (e.g., for air conditioner control), a coil driver (e.g., for ignition coil control), an EGR (exhaust gas recirculation) valve sensor, an air flow sensor (e.g., for fuel injection control), a manifold absolute pressure (MAP) sensor (e.g., for fuel injection control), an oil pan, a radiator cap, an intake manifold, and the like.

The formed body of this aspect is not limited to the automobile component exemplified above, and is suitably used for, for example, a high-voltage (harness) connector, a millimeter-wave radome, an IGBT (insulated gate bipolar transistor) housing, a battery fuse terminal, a radiator grille, a meter hood, a water pump for inverter cooling, a battery monitoring unit, a structural component, an intake manifold, a high-voltage connector, a motor control ECU (engine computer unit), an inverter, a piping component, a canister purge valve, a power unit, a bus bar, a motor speed reducer, a canister, and the like.

The formed body of this aspect is also preferably used for a motorcycle component and a bicycle component, and more specifically, examples thereof include a member for a motorcycle, a cowl for a motorcycle, and a member for a bicycle. Examples of the motorcycle/bicycle application include a motorcycle member, a motorcycle cowl, and a bicycle member.

The formed body of this aspect is excellent in chemical resistance, and therefore may be used in various electric appliances. For example, it is also preferable to constitute components of a natural refrigerant heat pump water heater known as a so-called “Eco Cute (a registered trade mark)” or the like, specifically. Such components include, for example, a shower component, a pump component, a piping component, and the like, and more specifically, a one-port circulating connection fitting, a relief valve, a mixing valve unit, a heat resistance trap, a pump casing, a complex water valve, a water-inlet fitting, a resin fitting, a piping component, a resin pressure reducing valve, an elbow for a water tap, and the like.

The formed body of this aspect is suitably used for components such as a home appliance and an electronic equipment, specifically, a phone, a mobile phone, a microwave oven, a refrigerator, a vacuum cleaner, an OA appliance, a power tool component, an electric tool component, an antistatic application, a high-frequency electronic component, a high-heat dissipation electronic component, a high-voltage component, an electromagnetic wave shielding component, a communication appliance, an AV appliance, a personal computer, a register, a fan, a ventilation fan, a sewing machine, an ink peripheral component, a ribbon cassette, an air cleaner component, a hot water flushing toilet seat component, a toilet seat, a toilet lid, a rice cooker component, an optical pick-up appliance, a luminaire component, a DVD, a DVD-RAM, a DVD pick-up component, a DVD pick-up board, a switch component, a socket, a display, a video camera, a filament, a plug, a high-speed color copiers (laser printer), an inverter, an air conditioner, a keyboard, a converter, a television, a facsimile, an optical connector, a semiconductor chip, an LED component, a laundering machine/laundering-drying machine component, a dishwasher/dishdryer component, and the like.

The formed body of this aspect is also suitably used for a building material, and more specifically, examples thereof include constituent members such as an outer wall panel, a back panel, a partition wall panel, a signal lamp, an emergency lamp, a wall material, and the like.

The formed body of this aspect is also suitably used for a general good, a daily necessity, etc., and more specifically, examples thereof include components such as a chopstick, a lunch box, a food container, a food tray, a food packaging material, a water tank, a tank, a toy, a sports article, a surfboard, a door cap, a door step, a Pachinko machine component, a remote control car, a remote controller case, stationery, a musical instrument, a tumbler, a dumbbell, a helmet box product, a shutter blade member used for cameras, etc., a racket member for table tennis or tennis, etc., and a plate member for a ski or snowboard, etc.

Each of the various components described above may be partially or entirely constituted by the resin composition according to the first aspect, the second aspect, or the third aspect of the invention, or a formed body containing the resin composition. Here, the formed body may be a stacked body or may not be a stacked body.

### 3. Method for Producing Polyarylene Ether

A method for producing a polyarylene ether (A) according to an aspect of the invention includes a step of heat-treating a raw material polyarylene ether at a temperature of 250 to 400° C. for 1 minute or longer to obtain a polyarylene ether (A) having a ratio of a peak integral value of 3.80 to 3.92 ppm relative to a peak integral value of 6.20 to 6.72 ppm being 0.05 to 5.0%, in ¹H-NMR spectrum obtained by ¹H-NMR spectrum measurement using deuterated chloroform as a solvent.

The explanation for the polyarylene ether (A) produced by the production method of this aspect will be explained by referring to the explanation for the polyarylene ether (A) contained in the resin composition according to the first aspect of the invention, and the detailed explanation will be omitted here.

The temperature of the heat treatment (it can also be referred to as the reaction temperature of the reaction for introducing the methylene bridge structure into the polyarylene ether) may be 250° C. or higher, and is preferably 270° C. or higher, higher than 270° C., 271° C. or higher, 275° C. or higher, 280° C. or higher, higher than 280° C., 281° C. or higher, 285° C. or higher, 290° C. or higher, 295° C. or higher, 300° C. or higher, higher than 300° C., 301° C. or higher, 305° C. or higher, 310° C. or higher, 320° C. or higher, or 330° C. or higher. By carrying out the heat treatment at such temperate, the reaction of introducing the methylene bridge structure into the polyarylene ether proceeds efficiently. The temperature of the heat treatment may be 400° C. or lower, and is preferably 380° C. or lower, 370° C. or lower, or even 350° C. or lower. When the temperature of the heat treatment exceeds 400° C., t the crosslinking reaction proceeds, which causes deterioration of forming processability and generation of foreign objects.

Typically, the polyarylene ether is melted at a temperature of 250 to 400° C.

The time of the heat treatment (which can also be referred to as the reaction time of the reaction of introducing the methylene bridge structure into the polyarylene ether) may be 1 minute or longer, and is preferably 2 minutes or longer, 4 minutes or longer, or even 5 minutes or longer. The longer the time of the heat treatment is, the more the reaction of introducing the methylene bridge structure into the polyarylene ether can proceed. The upper limit of the time of the heat treatment is not particularly limited, and for example, when the time is 3 hours or shorter, 2 hours or shorter, or even 1 hour or shorter, the production efficiency of the polyarylene ether (A) is increased. When the time of the heat treatment is 3 hours or shorter, preferably 2 hours or shorter, and more preferably 1 hour or shorter, the progress of the crosslinking reaction can be suppressed, and the deterioration of the forming processability and the generation of foreign objects can be suitably suppressed.

In the heat treatment, the polyarylene ether may be allowed to stand, the polyarylene ether may be pressurized, or a shear stress may be applied to the polyarylene ether.

In particular, in the heat treatment, it is preferable that a shear stress is applied to the polyarylene ether. By application of a shear stress, the ratio of the integral value (or MB rearrangement ratio) of the obtained polyarylene ether (A) can be remarkably increased as compared with the case of standing or pressurizing. Further, by applying a shear stress to the polyarylene ether in the heat treatment, the generation of insoluble components which may cause a decrease in physical properties can be suppressed.

The method of applying a shear stress to the polyarylene ether is not particularly limited, and examples thereof include a method of kneading the polyarylene ether. For kneading the polyarylene ether, a kneader such as a twin-screw kneader (for example, a twin-screw extruder) can be used.

As the heat treatment, it is preferable that the polyarylene ether is melt-kneaded (the polyarylene ether is kneaded in a molten state).

When a kneader is used for the heat treatment, the temperature of the heat treatment can be controlled to the above-described range by a heater provided in the kneader. Further, it is possible to control the time of the heat treatment as the residence time of the polyarylene ether in the kneader to the range described above.

The apparatus used for the heat treatment (for example, a kneader) may be a batch type apparatus, but is preferably a continuous type apparatus. That is, the apparatus used for the heat treatment is preferably configured such that the polyarylene ether continuously supplied to the apparatus is subjected to heat treatment continuously (preferably while kneading) in the apparatus, and the polyarylene ether (A) is continuously discharged from the apparatus. From this viewpoint, a continuous kneader having a heater such as a twin-screw kneader (for example, a twin-screw extruder) is preferably used.

In the above-described heat treatment, a catalyst that promotes MB rearrangement of the polyarylene ether can be used. The polyarylene ether is preferably heat-treated in the presence of a catalyst that promotes MB rearrangement of the polyarylene ether. The inventors have found that the radical-generating agent has an excellent catalytic function of promoting MB rearrangement of the polyarylene ether.

The radical-generating agent used as a catalyst for promoting MB rearrangement of the polyarylene ether is preferably one with a temperature indicating a half-life of 1 minute being lower than 400° C.

Specific examples of the radical-generating agent include, for example, 2,3-dimethyl-2,3-diphenylbutane, 2,3-diethyl-2,3-diphenylbutane, 2,3-diethyl-2,3-diphenylhexane, 2,3-dimethyl-2,3-di(p-methylphenyl) butane, and the like. Among them, 2,3-dimethyl-2,3-diphenylbutane with a temperature indicating a half-life of 1 minute being 285° C. is preferably used.

The proportion of the radical-generating agent used is preferably selected within a range of 0.1 to 10 parts by mass, more preferably 0.5 to 6 parts by mass, and still more preferably 1 to 3 parts by mass, based on 100 parts by mass of the polyarylene ether. When the proportion used is 0.1 parts by mass or more, methylene bridge rearrangement can be efficiently caused. In addition, when the proportion used is 10 parts by mass or less, the progress of the crosslinking reaction can be suppressed, and deterioration of the forming processability and generation of foreign objects can be suppressed.

In one embodiment, in the heat treatment described above, the polyarylene ether can be MB rearranged and the polyarylene ether can be modified with a modifying agent to obtain a polyarylene ether (A) modified with a functional group. The explanation for the modifying agent is referred to the explanation for the polyarylene ether (A) according to an aspect of the invention, and the detailed explanation will be omitted here.

It has been found that a modifying agent can inhibit MB rearrangement when using the modifying agent in a heat treatment to proceed with MB rearrangement. This makes it difficult that a radical-generating agent exhibits a function of promoting MB rearrangement. However, it has been found that MB rearrangement can be sufficiently proceeded by increasing the time of the heat treatment (longer than that for the purpose of only the modification), and the ratio of the integral value (or MB rearrangement ratio) equivalent to or more than that in the case of not using the modifying agent can be realized. When the purpose is only for the modification, the time of the heat treatment is sufficient for 1 minute, and a time longer than that can cause a decrease in productivity, but when the purpose is for both the modification and MB rearrangement, the time of the heat treatment is preferably 2 minutes or longer, more preferably 4 minutes or longer, and still more preferably 5 minutes or longer.

In one embodiment, a polyarylene ether modified with a functional group can be obtained by modifying a polyarylene ether with a modifying agent, and then the polyarylene ether modified with a functional group can be heat treated to obtain the polyarylene ether (A) modified with a functional group.

In the embodiment using the modifying agent described above, the proportion of the modifying agent used is preferably 0.5 to 10 parts by mass, more preferably 1 to 5 parts by mass, and still more preferably 2 to 4 parts by mass, based on 100 parts by mass of the polyarylene ether (which may be MB rearranged or may not be MB rearranged). When the proportion used is 0.5 parts by mass or more, a sufficient proportion of modifying (modifying degree) can be obtained, and when the proportion is 10 parts by mass or less, the modifying efficiency by the modifying agent can be kept good, and the modifying agent remained in the product (the polyarylene ether modified with a functional group) can be reduced.

In one embodiment, a polyarylene ether that is not modified with a functional group can be heat treated to obtain a polyarylene ether (A) that is not modified with a functional group.

It is preferable to produce the polyarylene ether (A) used in the carbon fiber-reinforced resin composition by the method for producing a polyarylene ether according to this aspect. The explanation for this carbon fiber-reinforced resin composition is referred to the explanation for the resin composition and the formed body according to the first aspect of the invention (particularly those containing a carbon fiber as an inorganic filler), and the detailed explanation will be omitted here.

### 5. Polyarylene Ether

The polyarylene ether according to an aspect of the invention has a ratio (“integral value ratio”) of a peak integral value of 3.80 to 3.92 ppm relative to a peak integral value of 6.20 to 6.72 ppm of 0.05 to 5.0%, in 1H-NMR spectrum obtained by measuring ¹H-NMR spectrum measurement using deuterated chloroform as a solvent. The explanation for the polyarylene ether of this aspect is referred to the explanation for the polyarylene ether (A) contained in the resin composition according to the first aspect of the invention, and the detailed explanation will be omitted here.

The polyarylene ether according to this aspect is preferably used in a carbon fiber-reinforced resin composition. The explanation for this carbon fiber-reinforced resin composition is referred to the explanation for the resin composition and the formed body according to the first aspect of the invention (particularly those containing a carbon fiber as an inorganic filler), and the detailed explanation will be omitted here.

### EXAMPLES

Examples of the invention will be described below, but the invention is not limited to these Examples.

### 1. Preparation of Polyarylene Ether (A)

### Example 1

100 parts by mass of polyphenylene ether (“LXR040” manufactured by BLUESTAR NEW CHEMICAL MATERIALS Co., Ltd., poly(2,6-dimethyl-1,4-phenylether)) as a raw material of a polyarylene ether was heat-treated by using a twin-screw extruder (“Process-11” manufactured by Thermo Fisher Scientific, Inc., cylinder volume: 20 cc) having a cylinder diameter of 11 mm while melt-kneading at a screw rotational speed of 200 rpm and a set temperature of 330° C. The raw material was fed at 10 g/minute from the root of the twin-screw extruder (upstream of the screws). In this heat treatment, the resin temperature (reaction temperature) was 330° C. and the residence time (reaction time) was 2 minutes. The residence time corresponds to the time of the heat treatment (reaction time), and is obtained by dividing the cylinder volume by the supply amount.

Strands were cooled and pelletized to obtain polyarylene ether (A-1).

### <Evaluation Method>

### ¹H-NMR Measurement

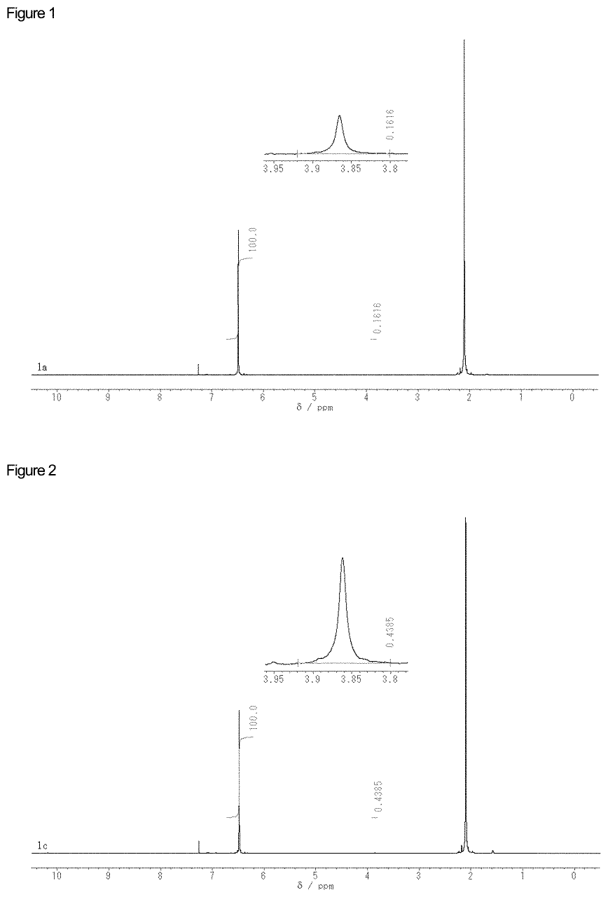

The obtained polyarylene ether (A-1) was subjected to ¹H-NMR measurement under the following conditions, and a ratio of the peak integral value of 3.80 to 3.92 ppm relative to the peak integral value of 6.20 to 6.72 ppm, in the obtained ¹H-NMR spectrum (“integral value ratio,” unit: [%]) was determined. The results are shown in Table 1. The ¹H-NMR spectrum is shown in FIG. 1.

### [¹H-NMR Measurement Condition]

Apparatus: ECA500 (manufactured by JEOL Ltd.)
Observation nuclear. 1H
Observation frequency: 495.13 MHz
Measuring method: Single-Plus
Pulse width: 6.69 usec
Wait time: 7.36 seconds
Cumulated number: 256 times
Solvent: deuterated chloroform (CDCl₃)
Sample concentration: 5% by mass
Chemical shift reference: 7.26 ppm (CHCl₃)

Here, the peak integral value of 6.20 to 6.72 ppm is determined as an area of the region surrounded by a straight line connecting the intensity at 6.20 ppm and the intensity at 6.72 ppm, and the peak(s) therebetween. The peak integral value of 3.80 to 3.92 ppm was determined as the area of the region surrounded by a straight line connecting the intensity at 3.80 ppm and the intensity at 3.92 ppm, and the peak(s) therebetween.

### Example 2

A polyarylene ether (A-2) was obtained in the same manner as in Example 1 except that the time of the heat treatment (reaction time) was changed to 6 minutes. The obtained polyarylene ether (A-2) was evaluated in the same manner as in Example 1, and the results are shown in Table 1. The ¹H-NMR spectrum is shown in FIG. 2.

### Example 3

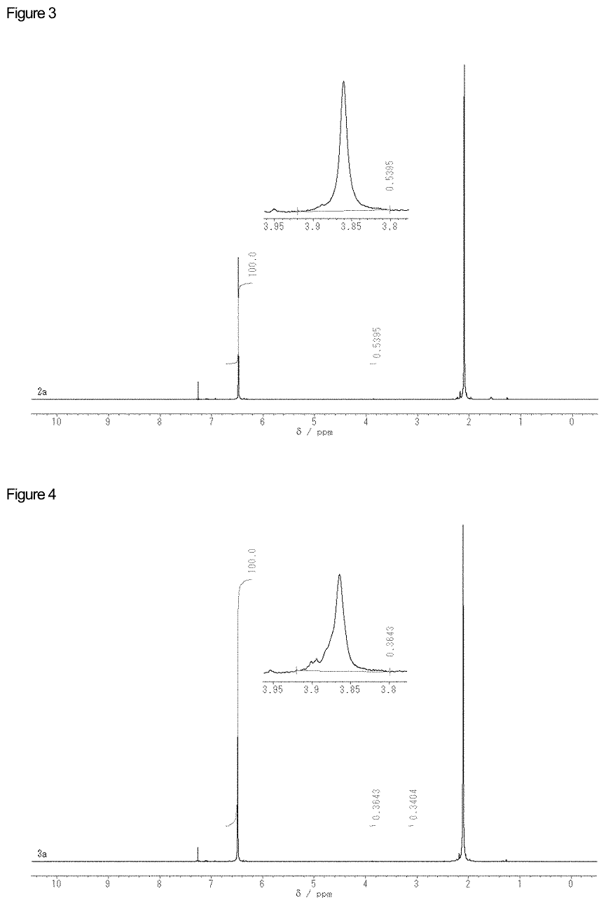

A polyarylene ether (A-3) was obtained in the same manner as in Example 1, except that 2 parts by mass of a radical-generating agent (“Nofmer BC90”, manufactured by NOF CORPORATION, 2,3-dimethyl-2,3-diphenylbutane) was dry-blended and supplied to a twin-screw extruder in 100 parts by mass of a polyarylene ether (polyphenylene ether) as a raw material. The obtained polyarylene ether (A-3) was evaluated in the same manner as in Example 1, and the results are shown in Table 1. The ¹H-NMR spectrum is shown in FIG. 3.

### Example 4

A polyarylene ether (A-4) was obtained in the same manner as in Example 1, except that 2 parts by mass of a radical-generating agent (“Nofmer BC90”, manufactured by NOF CORPORATION, 2,3-dimethyl-2,3-diphenylbutane) and 2 parts by mass of a modifying agent (fumaric acid) were dry-blended and supplied to a twin-screw extruder in 100 parts by mass of a polyarylene ether (polyphenylene ether) as a raw material. The obtained polyarylene ether (A-4) was evaluated in the same manner as in Example 1, and the fumaric acid modification ratio was further measured. The results are shown in Table 1. The ¹H-NMR spectrum is shown in FIG. 4.

### <Evaluation Method>

### Measurement of Fumaric Acid Modification Ratio

The obtained polyarylene ether (A-4) was subjected to ¹H-NMR measurement under the same conditions as in the above-described “¹H-NMR measurement,” and a ratio of the value obtained by dividing the peak integral value of 3.06 to 3.17 ppm by the number of proton derived from the structure of the methylene position bonded to the fumaric acid of 1, relative to the value obtained by dividing the peak integral value of 6.20 to 6.72 ppm by the number of protons derived from the phenylene ether structure of 2, in the obtained ¹H-NMR spectrum (also referred to as “fumaric acid modification ratio,” unit: [%]) was determined. The result is shown in Table 1.

Here, the peak integral value of 6.20 to 6.72 ppm was determined as an area of the region surrounded by a straight line connecting the intensity at 6.20 ppm and the intensity at 6.72 ppm, and the peak(s) therebetween. The peak integral value of 3.06 to 3.17 ppm was determined as an area of the region surrounded by a straight line connecting the intensity at 3.06 ppm and the intensity at 3.17 ppm, and the peak(s) therebetween.

### Example 5

A polyarylene ether (A-5) was obtained in the same manner as in Example 1 except that the time of the heat treatment (reaction time) was changed to 10 minutes. The obtained polyarylene ether (A-5) was evaluated in the same manner as in Example 1, and the fumaric acid modification ratio was further measured. The results are shown in Table 1.

### Example 6

A polyarylene ether (A-6) was obtained in the same manner as in Example 1 except that the time of the heat treatment (reaction time) was changed to 1 minute. The obtained polyarylene ether (A-6) was evaluated in the same manner as in Example 1, and the fumaric acid modification ratio was further measured. The results are shown in Table 1.

### Comparative Example 1

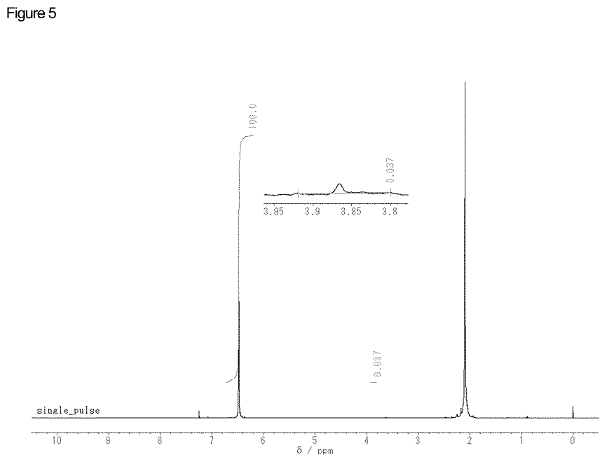

The polyphenylene ether used as a raw material in Examples 1 to 6 (“LXR040,” manufactured by Bluestar New Chemical Material Co., Ltd, poly(2,6-dimethyl-1,4-phenyl ether) was evaluated in the same manner as in Example 1, and are shown in Table 1. The ¹H-NMR spectrum is shown in FIG. 5.

TABLE 1

| | | Example 1 | Example 2 | Example 3 | Example 4 | Example 5 | Example 6 | Comp. Ex. 1 |
|---|---|---|---|---|---|---|---|---|
| | | (A-1) | (A-2) | (A-3) | (A-4) | (A-5) | (A-6) | (B-1) |
| Blending | Polyphenylene ether | 100 | 100 | 100 | 100 | 100 | 100 | 100 |
| amount [parts | Radical-generating agent | 0 | 0 | 2 | 2 | 2 | 2 | 0 |
| by mass] | Modifying agent | 0 | 0 | 0 | 2 | 2 | 2 | 0 |
| MB | Reaction temperature [° C.] | 330 | 330 | 330 | 330 | 330 | 330 | None |
| rearrangement | Reaction time [min] | 2 | 6 | 2 | 2 | 10 | 1 | None |
| reaction | | | | | | | | |
| condition | | | | | | | | |

| | | | | | | | |
|---|---|---|---|---|---|---|---|
| Integral value ratio [%] | 0.16 | 0.44 | 0.54 | 0.36 | 0.67 | 0.28 | 0.04 |
| Fumaric acid modification ratio [%] | — | — | — | 0.68 | 1.13 | 0.48 | — |

### <Evaluation>

From Table 1, it was found that the polyarylane other (A) was obtained by heat-treating a polyarylane other under specific conditions. In addition, it was found that the integral value ratio of the obtained polyarylane either (A) can be further increased by heat treating a polyarylane either in the presence of a radical-generating agent under specific conditions.

Incidentally, in Example 1, when the time of the heat treatment (reaction time) was changed to 60 minutes, the integral value ratio of the polyarylene ether (A) obtained was 1.21%, but by-produced foreign objects (insoluble matter when dissolved in chloroform) were mixed. These foreign objects can be removed by purification (such as filtration in a state in which the polyarylene ether (A) is dissolved in chloroform), if necessary.

### Example 7

Pellets of the resin composition were obtained by side-feeding of 30 parts by mass of an inorganic filler (C) (“TR03CMA4G” manufactured by Mitsubishi Engineering-Plastics Corporation, carbon fiber, filament diameter. 7 μm) using a twin-screw extruder having a cylinder diameter of 11 mm (“Process-11” manufactured by Thermo Fisher Scientific, Inc.) to 100 parts by mass of a resin(S) composed of 10% by mass of the polyarylene ether (A-1) obtained in Example 1 and 90% by mass of a thermoplastic resin (B) (manufactured by Idemitsu Kosan Co., Ltd., SPS, MFR: 9 g/10 min), and kneading.

### <Evaluation Method>

### Measurement of Flexural Strength

The obtained pellets were subjected to injection-molding using an injection-molding machine (“Mini Jet Pro” manufactured by Thermo Fisher Scientific, Inc.) at a cylinder temperature of 320° C. and a mold temperature of 150° C., and a flexural test piece (width: 5 mm, thickness: 4 mm, length: 75 mm) was prepared. The flexural strength [MPa] of this flexural test piece was measured under conditions of a distance between fulcrums of 64 mm, at a temperature of 23° C., and a bending speed of 2 mm/min. The larger the value becomes, the better the mechanical strength indicates. The result is shown in Table 2.

### ¹H-NMR Measurement

The obtained pellets were pulverized by ZM200 Ultra Centrifugal Mill using a 1.5 mm screen filter. The pulverized product in an amount of 1 g was placed in a cylindrical filter paper (No. 86R, ID: 24 mm, OD: 28 mm, L: 100 mm, manufactured by Advantech Co., Ltd) and attached to a Soxhlet extractor (“B-811,” manufactured by Nihon BUCHI K.K.). As the extraction solvent, 150 ml of chloroform was used. The extraction mode was set to Soxhlet extraction mode and the heating levels of the upper and lower heaters were set to 4 and 10, respectively. The extraction time was set for 8 hours, and the extraction operation was performed. The extraction liquid was air-dried by a nitrogen sprayer and then dried in a vacuum dryer at 60° C. for 1 hour to obtain an extract. After adding deuterated chloroform to redissolve the extract, deuterated benzene was mixed (CDCl₃/C₆D₆=3/1 (v/v) to obtain a sample for measurement.

The obtained sample for measurement was subjected to ¹H-NMR measurement within 1 hour from the addition of deuterated benzene under the following conditions, and a ratio of the value obtained by dividing the peak integral value of 3.73 to 3.82 ppm by 2, relative to the sum of the value obtained by dividing the peak integral value of 1.96 to 2.43 ppm by 6 and the value obtained by dividing the peak integral value of 3.73 to 3.82 ppm by 2, in the obtained ¹H-NMR spectrum (“integral value ratio,” unit: [%]) was determined. The result is shown in Table 2.

### [¹H-NMR Measurement Condition]

Apparatus: ECA500 (manufactured by JEOL Ltd.)
Observation nuclear: 1H
Observation frequency: 495.13 MHZ
Measuring method: Single-Plus
Pulse width: 6.69 usec
Wait time: 7.36 seconds
Measurement temperature: 60° C.
Cumulated number: 256 times
Solvent: deuterated chloroform/deuterated benzene (CDCl₃/C₈D₈=3/1 (v/v))
Sample concentration: 5% by mass
Chemical shift reference: 7.26 ppm (CHCl₃)

Here, the peak integral value of 1.96 to 2.43 ppm is determined as an area of the region surrounded by a straight line connecting the intensity at 1.96 ppm and the intensity at 2.43 ppm, and the peak(s) therebetween. The peak integral value of 3.73 to 3.82 ppm is determined as an area of the region surrounded by a straight line connecting the intensity at 3.73 ppm and the intensity at 3.82 ppm, and the peak(s) therebetween.

### Example 8

Pellets of the resin composition were obtained in the same manner as in Example 7, except that the polyarylene ether (A-2) obtained in Example 2 was used in place of the polyarylene ether (A-1). The obtained pellets were evaluated in the same manner as in Example 7. The results are shown in Table 2.

### Example 9

Pellets of the resin composition were obtained in the same manner as in Example 7, except that the polyarylene ether (A-3) obtained in Example 3 was used in place of the polyarylene ether (A-1). The obtained pellets were evaluated in the same manner as in Example 7. The results are shown in Table 2.

### Example 10

Pellets of the resin composition were obtained in the same manner as in Example 7, except that the polyarylene ether (A-4) obtained in Example 4 was used in place of the polyarylene ether (A-1). The obtained pellets were evaluated in the same manner as in Example 7. The results are shown in Table 2.

### Example 11

Pellets of the resin composition were obtained in the same manner as in Example 7, except that the polyarylene ether (A-5) obtained in Example 5 was used in place of the polyarylene ether (A-1). The obtained pellets were evaluated in the same manner as in Example 7. The results are shown in Table 2.

### Example 12

Pellets of the resin composition were obtained in the same manner as in Example 7, except that the polyarylene ether (A-6) obtained in Example 6 was used in place of the polyarylene ether (A-1). The obtained pellets were evaluated in the same manner as in Example 7. The results are shown in Table 2.

### Comparative Example 2

Pellets of the resin composition were obtained in the same manner as in Example 7, except that the polyphenylene ether of Comparative Example 1 was used in place of the polyarylene ether (A-1). The obtained pellets were evaluated in the same manner as in Example 7. The results are shown in Table 2.

### Comparative Example 3

Pellets of the resin composition were obtained by dry-blending 0.2 parts by mass of a radical-generating agent and 0.2 parts by mass of the modifying agent to 100 parts by mass of a resin(S) composed of 10 parts by mass of the polyarylene ether of Comparative Example 1 and 90 parts by mass of a thermoplastic resin (B) (manufactured by Idemitsu Kosan Co., Ltd., SPS, MFR: 9 g/10 min), supplying the dry-blend into a twin-screw extruder with a cylinder having a diameter of 11 mm (“Process-11” manufactured by Thermo Fisher Scientific, Inc.), and kneading the dry-blend while side-feeding 30 parts by mass of an inorganic filler (C) (“TR03CMA4G” manufactured by Mitsubishi Engineering-Plastics Corporation, carbon fiber, filament diameter: 7 μm). The obtained pellets were evaluated in the same manner as in Example 7. The results are shown in Table 2.

TABLE 2

| | | | Example 7 | Example 8 | Example 9 | Example 10 | Example 11 | Example 12 | Comp. Ex. 2 | Comp. Ex. 3 |
|---|---|---|---|---|---|---|---|---|---|---|
| Blending | Polyarylene ether (A) | (A-1) | 10 | 0 | 0 | 0 | 0 | 0 | 0 | 0 |
| amount | | (A-2) | 0 | 10 | 0 | 0 | 0 | 0 | 0 | 0 |
| [parts by | | (A-3) | 0 | 0 | 10 | 0 | 0 | 0 | 0 | 0 |
| mass] | | (A-4) | 0 | 0 | 0 | 10 | 0 | 0 | 0 | 0 |
| | | (A-5) | 0 | 0 | 0 | 0 | 10 | 0 | 0 | 0 |
| | | (A-6) | 0 | 0 | 0 | 0 | 0 | 10 | 0 | 0 |

| | | | | | | | | |
|---|---|---|---|---|---|---|---|---|
| Polyphenylene ether | 0 | 0 | 0 | 0 | 0 | 0 | 10 | 10 |
| Thermoplastic resin (B) | 90 | 90 | 90 | 90 | 90 | 90 | 90 | 90 |
| Radical-generating agent | 0 | 0 | 0 | 0 | 0 | 0 | 0 | 0.2 |
| Modifying agent | 0 | 0 | 0 | 0 | 0 | 0 | 0 | 0.2 |
| Inorganic filler (C) | 30 | 30 | 30 | 30 | 30 | 30 | 30 | 30 |

| | | | | | | | | |
|---|---|---|---|---|---|---|---|---|
| Flexural strength [MPa] | 206 | 214 | 216 | 235 | 251 | 223 | 194 | 210 |
| Integral value ratio [%] | 0.12 | 0.35 | 0.48 | 0.31 | 0.59 | 0.23 | 0 | 0.03 |

The polyphenylene ether of Comparative Example 1 does not correspond to the polyarylene ether (A) having the ratio of the peak integral value of 3.80 to 3.92 ppm to the peak integral value of 6.20 to 6.72 ppm in 1H-NMR spectrum obtained by ¹H-NMR spectrum measurement using deuterated chloroform as a solvent being 0.05 to 5.0%, and corresponds to the thermoplastic resin (B). Therefore, the total blending amount of the thermoplastic resin (B) in Comparative Examples 2 and 3 is 100 parts by mass (90 parts by mass+10 parts by mass).

### <Evaluation>

From Table 2, it was found that the resin composition containing the polyarylene ether (A) exhibits increased flexural strength. It was also found that this effect is further increased by modifying the polyarylene ether (A) with a functional group.

### Example 13

Pellets of a resin(S) was obtained by kneading a resin(S) composed of 10 parts by mass of the polyarylene ether (A-2) obtained in Example 2 and 90 parts by mass of a thermoplastic resin (B) (manufactured by Idemitsu Kosan Co., Ltd., SPS, MFR: 9 g/10 min) using a twin-screw extruder with a cylinder having a diameter of 11 mm (“Process-11” manufactured by Thermo Fisher Scientific, Inc.). The flexural strength was measured for the obtained pellets in the same manner as in Example 7, and the interfacial shear strength was measured by the measurement method described below. The results are shown in Table 3.

### Measurement of Interfacial Shear Strength (Microdroplet Method)

In order to evaluate the interfacial shear strength between a resin(S) and a monofilament (carbon fiber) in the resin composition, the following test was performed in accordance with the microdroplet method.

The “microdroplet method” is a method of evaluating the interfacial adhesion between a monofilament and a resin by attaching a resin particle (droplet) to the monofilament, fixing the droplet, followed by a pull-out test of the single fiber from the droplet. In the microdroplet method, the interface shear strength is calculated from the following formula:

T=F/(πDL)

In the formula, T is the interfacial shear strength, F is the maximum pull-out load, L is the length of the portion of the monofilament embedded in the droplet, and D is the fiber diameter.

In this Examples, using a “MODEL HM410” manufactured by TOUEISANGYO CORPORATION, a droplet was formed in a nitrogen atmosphere at a preparation temperature of 270° C., then the temperature of the droplet was decreased to room temperature, and the test was carried out at the drawing speed of 0.12 mm/min with the maximum load of the load cell of 1N. As the carbon fiber, “TR50S15L” (fiber diameter: 7 μm) manufactured by Mitsubishi Chemical Corporation was used. The test was performed 20 times, and the interfacial shear strength [MPa] was determined as the average value of the 20 tests.

### Example 14

Pellets of the resin(S) were obtained in the same manner as in Example 13, except that the polyarylene ether (A-4) obtained in Example 4 was used in place of the polyarylene ether (A-2). The obtained pellets were evaluated in the same manner as in Example 13. The results are shown in Table 3.

### Example 15

Pellets of the resin(S) were obtained in the same manner as in Example 13, except that the polyarylene ether (A-5) obtained in Example 5 was used in place of the polyarylene ether (A-2). The obtained pellets were evaluated in the same manner as in Example 13. The results are shown in Table 3.

### Example 16

Pellets of the resin(S) were obtained in the same manner as in Example 13, except that the polyarylene ether (A-6) obtained in Example 6 was used in place of the polyarylene ether (A-2). The obtained pellets were evaluated in the same manner as in Example 13. The results are shown in Table 3.

### Comparative Example 4

Pellets of the resin were obtained in the same manner as in Example 13, except that the polyphenylene ether of Comparative Example 1 was used in place of the polyarylene ether (A-2). The obtained pellets were evaluated in the same manner as in Example 13. The results are shown in Table 3.

TABLE 3

| | | | Example 13 | Example 14 | Example 15 | Example 16 | Comp. Ex. 4 |
|---|---|---|---|---|---|---|---|
| Blending | Polyarylene | (A-2) | 10 | 0 | 0 | 0 | 0 |
| amount | ether (A) | (A-4) | 0 | 10 | 0 | 0 | 0 |
| [parts by | | (A-5) | 0 | 0 | 10 | 0 | 0 |
| mass] | | (A-6) | 0 | 0 | 0 | 10 | 0 |

| | | | | | |
|---|---|---|---|---|---|
| Polyphenylene ether | 0 | 0 | 0 | 0 | 10 |
| Thermoplastic resin (B) | 90 | 90 | 90 | 90 | 90 |

| | | | | | |
|---|---|---|---|---|---|
| Flexural strength [MPa] | 102 | 101 | 100 | 100 | 102 |
| Integral value ratio [%] | 31 | 45 | 55 | 39 | 26 |

### <Evaluation>

From Table 3, significant affect was not observed for the flexural strength of the resin(S) alone due to addition of the polyarylene ether (A). On the other hand, it can be seen that the resin(S) containing the polyarylene ether (A) is superior in the interfacial shear strength to the resin containing no polyarylene ether (A). From this fact, it can be seen that the polyarylene ether (A) can increase the adhesiveness between fibers and the resin(S) due to MB rearrangement, and is suitable as a fiber-reinforced resin composition such as a carbon-fiber-reinforced resin composition.

### Example 17

The polyphenylene ether of Comparative Example 1 was heat-treated using a rheometer (MCR302 manufactured by Anton Paar GmbH) in a nitrogen atmosphere (flow rate: 500 NL/h) at a set temperature of 330° C. for a holding time of 10 minutes to obtain a polyarylene ether. The integral value ratio of the obtained polyarylene ether was determined in the same manner as in Example 1. The interface shear strength was measured in the same manner as in Example 15. The results are shown in Table 4.

### Example 18

A polyarylene ether was obtained in the same manner as in Example 17 except that the set temperature was changed to 300° C. The obtained polyarylene ether was evaluated in the same manner as in Example 17. The results are shown in Table 4.

### Comparative Example 5

A polyarylene ether was obtained in the same manner as in Example 17 except that the set temperature was changed to 270° C. The obtained polyarylene ether was evaluated in the same manner as in Example 17. The results are shown in Table 4.

TABLE 4

| | | Example 17 | Example 18 | Comp. Ex. 5 |
|---|---|---|---|---|
| MB | Reaction | 330 | 300 | 270 |
| rearrangement | temperature [° C.] | | | |
| reaction | Reaction time [min] | 10 | 10 | 10 |
| condition | | | | |

| | | | |
|---|---|---|---|
| Integral value ratio [%] | 0.62 | 0.21 | 0.03 |
| Fumaric acid modification ratio [%] | 75 | 84 | 72 |

### <Evaluation>

From Table 4, it can be seen that MB rearrangement proceeds efficiently by setting the reaction temperature high for MB rearrangement reaction. It can be seen that the progress of MB rearrangement of the polyarylene ether increases the adhesiveness to a fiber (here, carbon fibers).

Although only some exemplary embodiments and/or examples of this invention have been described in detail above, those skilled in the art will readily appreciate that many modifications are possible in the exemplary embodiments and/or examples without materially departing from the novel teachings and advantages of this invention. Accordingly, all such modifications are intended to be included within the scope of this invention.

1. A resin composition comprising:
a resin(S) comprising:
a polyarylene ether (A) having a ratio of a peak integral value of 3.80 to 3.92 ppm relative to a peak integral value of 6.20 to 6.72 ppm being 0.05 to 5.0%, in ¹H-NMR spectrum obtained by ¹H-NMR spectrum measurement using deuterated chloroform as a solvent; and
a thermoplastic resin (B), and
an inorganic filler (C).

2. A resin composition comprising:
a resin(S) comprising:
a polyarylene ether (A); and
a thermoplastic resin (B), and
an inorganic filler (C), wherein
a ratio of a peak integral value of 3.80 to 3.92 ppm relative to a peak integral value of 6.20 to 6.72 ppm is 0.05 to 5.0%, in ¹H-NMR spectrum for the resin composition obtained by ¹H-NMR spectrum measurement using deuterated chloroform as a solvent . . .

3. A resin composition comprising:
a resin(S) comprising:
a polyarylene ether (A); and
a thermoplastic resin (B), and
an inorganic filler (C), wherein
a ratio of a value obtained by dividing a peak integral value of 3.80 to 3.92 ppm by 2, relative to a sum of a value obtained by dividing a peak integral value of 1.96 to 2.43 ppm by 6 and a value obtained by dividing a peak integral value of 3.80 to 3.92 ppm by 2 is 0.05 to 5.0%, in ¹H-NMR spectrum for the resin composition obtained by ¹H-NMR spectrum measurement using deuterated chloroform as a solvent.

4. The resin composition according to claim 1, wherein the polyarylene ether (A) is a polyarylene ether modified with a functional group.

5. The resin composition according to claim 1, wherein the polyarylene ether (A) is a dicarboxylic acid-modified polyarylene ether.

6. The resin composition according to claim 1, wherein the polyarylene ether (A) is a fumaric acid-modified polyarylene ether or a maleic anhydride-modified polyarylene ether.

7. The resin composition according to claim 1, wherein the polyarylene ether (A) is contained in an amount of 0.5 to 30% by mass in 100% by mass of the resin(S).

8. The resin composition according to claim 1, comprising the inorganic filler (C) in an amount of 1 to 500 parts by mass relative to 100 parts by mass of the resin(S).

9. The resin composition according to claim 1, wherein the thermoplastic resin (B) is at least one selected from the group consisting of a polycarbonate-based resin, a polystyrene-based resin, a polyamide, and a polyolefin.

10. The resin composition according to claim 1, wherein the thermoplastic resin (B) is a styrene-based resin having a syndiotactic structure.

11. The resin composition according to claim 1, wherein the inorganic filler (C) is an inorganic fiber.

12. The resin composition according to claim 11, wherein the inorganic fiber is carbon fiber.

13. The resin composition according to claim 12, wherein the carbon fiber is at least one carbon fiber selected from the group consisting of a PAN-based carbon fiber, a pitch-based carbon fiber, a heat-curing carbon fiber, a phenol-based carbon fiber, a vapor-phase growth carbon fiber, and a recycled carbon fiber (RCF).

14. A formed body, comprising the resin composition according to claim 1.

15. The formed body according to claim 14, which is a unidirectional fiber reinforcing material.

16. The formed body according to claim 14, comprising at least one member selected from the group consisting of a woven carbon fiber and a non-woven carbon fiber.

17. The formed body according to claim 14, which is an injection-molded body.

18. A stacked body obtained by stacking a plurality of the formed bodies according to claim 14.

19. A method for producing a polyarylene ether having a ratio of a peak integral value of 3.80 to 3.92 ppm, relative to a peak integral value of 6.20 to 6.72 ppm being 0.05 to 5.0%, in ¹H-NMR spectrum obtained by ¹H-NMR spectrum measurement using deuterated chloroform as a solvent, comprising:
heat-treating a raw material polyarylene ether at a temperature of 250 to 400° C. for 1 minute or longer.

20. The method for producing a polyarylene ether (A) according to claim 19, wherein a shear stress is applied to the polyarylene ether during the heat-treating.

21. The method for producing a polyarylene ether (A) according to claim 19, producing the polyarylene ether (A) used in a carbon fiber-reinforced resin composition.

22. A polyarylene ether, having a ratio of a peak integral value of 3.80 to 3.92 ppm relative to a peak integral value of 6.20 to 6.72 ppm of 0.05 to 5.0%, in ¹H-NMR spectrum obtained by ¹H-NMR spectrum measurement using deuterated chloroform as a solvent.

23. The polyarylene ether according to claim 22, used for a carbon fiber-reinforced resin composition.
